(19) United States
(12) Patent Application Publication
(10) Pub. No.: US 2026/0012907 A1
(43) Pub. Date: Jan. 8, 2026

(54) SS/PBCH BLOCK STRUCTURE

(71) Applicant: Samsung Electronics Co., Ltd., Suwon-si (KR)

(72) Inventors: Jiayu Mao, Columbus, OH (US); Hongbo Si, Allen, TX (US)

(21) Appl. No.: 19/234,185

(22) Filed: Jun. 10, 2025

Related U.S. Application Data
(60) Provisional application No. 63/667,525, filed on Jul. 3, 2024.
(60) Provisional application No. 63/669,103, filed on Jul. 9, 2024.

(51) Int. Cl. H04W 56/00; H04L 5/00; H04W 72/0446; H04W 72/0453

(52) U.S. Cl. CPC H04W 56/0015; H04L 5/0007; H04W 72/0446; H04W 72/0453

(57) ABSTRACT

Methods and apparatuses for synchronization signal/physical broadcast channel (SS/PBCH) block structure(s). A method performed by a user equipment (UE) in a wireless communication system includes identifying a structure for a SS/PBCH block, the structure including a first number N_{symb} of orthogonal frequency-division multiplexing (OFDM) symbols in a time domain and a second number N_{RB} of resource blocks (RBs) in a frequency domain and identifying, from the N_{symb} OFDM symbols, a third number N₁ of OFDM symbols mapped for a primary synchronization signal (PSS), where N₁>1. The method further includes identifying, from the N_{symb} OFDM symbols, a fourth number N₂ of OFDM symbols mapped for a secondary synchronization signal (SSS), where N₂>1 and receiving the SS/PBCH block based on the structure.

### CROSS-REFERENCE TO RELATED AND CLAIM OF PRIORITY

The present application claims priority under 35 U.S.C. § 119 (e) to U.S. Provisional Patent Application No. 63/667,525 filed on Jul. 3, 2024 and U.S. Provisional Patent Application No. 63/669,103 filed on Jul. 9, 2024, which are hereby incorporated by reference in their entirety.

### TECHNICAL FIELD

The present disclosure relates generally to wireless communication systems and, more specifically, the present disclosure relates to methods and apparatuses for synchronization signals/physical broadcast channel (SS/PBCH) block structure(s).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to SS/PBCH block structure(s).

In one embodiment, a user equipment (UE) in a wireless communication system is provided. The UE includes a processor configured to identify a structure for a SS/PBCH block, the structure including a first number N_{symb} of orthogonal frequency-division multiplexing (OFDM) symbols in a time domain and a second number N_{RB} of resource blocks (RBs) in a frequency domain, identify, from the N_{symb} OFDM symbols, a third number N₁ of OFDM symbols mapped for a primary synchronization signal (PSS), where N₁>1, and identify, from the N_{symb} OFDM symbols, a fourth number N₂ of OFDM symbols mapped for a secondary synchronization signal (SSS), where N₂>1. The UE further includes a transceiver operably coupled to the processor. The transceiver is configured to receive the SS/PBCH block based on the structure.

In another embodiment, a base station (BS) in a wireless communication system is provided. The BS includes a processor configured to determine a structure for a SS/PBCH block, the structure including a first number N_{symb} of OFDM symbols in a time domain and a second number N_{RB} of RBs in a frequency domain, determine, from the N_{symb} OFDM symbols, a third number N₁ of OFDM symbols mapped for a PSS, where N₁>1, and determine, from the N_{symb} OFDM symbols, a fourth number N₂ of OFDM symbols mapped for a SSS, where N₂>1. The BS further includes a transceiver operably coupled to the processor. The transceiver is configured to transmit the SS/PBCH block based on the structure.

In yet another embodiment, a method performed by a UE in a wireless communication system is provided. The method includes identifying a structure for a SS/PBCH block, the structure including a first number N_{symb} of OFDM symbols in a time domain and a second number N_{RB} of RBs in a frequency domain and identifying, from the N_{symb} OFDM symbols, a third number N₁ of OFDM symbols mapped for a PSS, where N₁>1. The method further includes identifying, from the N_{symb} OFDM symbols, a fourth number N₂ of OFDM symbols mapped for a SSS, where N₂>1 and receiving the SS/PBCH block based on the structure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example SS/PBCH block architecture according to embodiments of the present disclosure;

FIG. 6 illustrates diagrams of example synchronization signal block (SSB) architectures according to embodiments of the present disclosure;

FIG. 7 illustrates diagrams of example SSB architectures according to embodiments of the present disclosure;

FIG. 8 illustrates diagrams of example SSB architectures according to embodiments of the present disclosure;

FIG. 9 illustrates diagrams of example SSB architectures according to embodiments of the present disclosure;

FIG. 10 illustrates diagrams of example SSB architectures according to embodiments of the present disclosure;

FIG. 11 illustrates diagrams of example SSB architectures according to embodiments of the present disclosure;

FIG. 12 illustrates diagrams of example SSB architectures according to embodiments of the present disclosure;

FIG. 13 illustrates diagrams of example SSB architectures according to embodiments of the present disclosure;

FIG. 14 illustrates a flowchart of an example UE procedure for receiving signal(s)/channel(s) according to embodiments of the present disclosure;

FIG. 15 illustrates diagrams of example SSB architectures according to embodiments of the present disclosure;

FIG. 16 illustrates diagrams of example SSB architectures according to embodiments of the present disclosure;

FIG. 17 illustrates diagrams of example SSB architectures according to embodiments of the present disclosure;

FIG. 18 illustrates diagrams of example SSB architectures according to embodiments of the present disclosure;

FIG. 19 illustrates diagrams of example SSB architectures according to embodiments of the present disclosure;

FIG. 20 illustrates diagrams of example SSB architectures according to embodiments of the present disclosure;

FIG. 21 illustrates diagrams of example SSB architectures according to embodiments of the present disclosure;

FIG. 22 illustrates diagrams of example SSB architectures according to embodiments of the present disclosure;

FIG. 23 illustrates diagrams of example SSB architectures according to embodiments of the present disclosure;

FIG. 24 illustrates diagrams of example SSB architectures according to embodiments of the present disclosure; and

FIG. 25 illustrates a flowchart of an example UE procedure for receiving signal(s)/channel(s) according to embodiments of the present disclosure.

### DETAILED DESCRIPTION

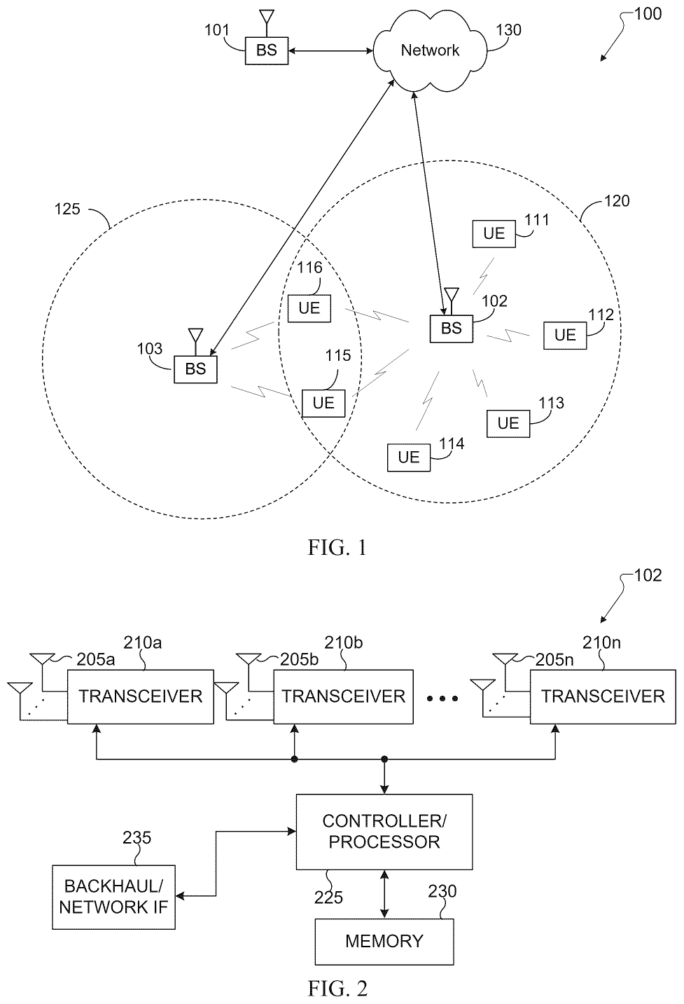

FIGS. 1-25, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band.

For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.0.0, “NR; Physical channels and modulation;” [REF 2] 3GPP TS 38.212 v18.0.0, “NR; Multiplexing and channel coding;” [REF 3] 3GPP TS 38.213 v18.0.0, “NR; Physical layer procedures for control;” [REF 4] 3GPP TS 38.214 v18.0.0, “NR; Physical layer procedures for data;” and [REF 5] 3GPP TS 38.331 v18.0.0, “NR; Radio Resource Control (RRC) protocol specification.”

FIGS. 1-3 below describe various embodiments implemented in wireless communications systems and with the use of OFDM or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying a SS/PBCH block structure(s). In certain embodiments, one or more of the BSs 101-103 include circuitry, programing, or a combination thereof to support SS/PBCH block structure(s).

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for SS/PBCH block structure(s). The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

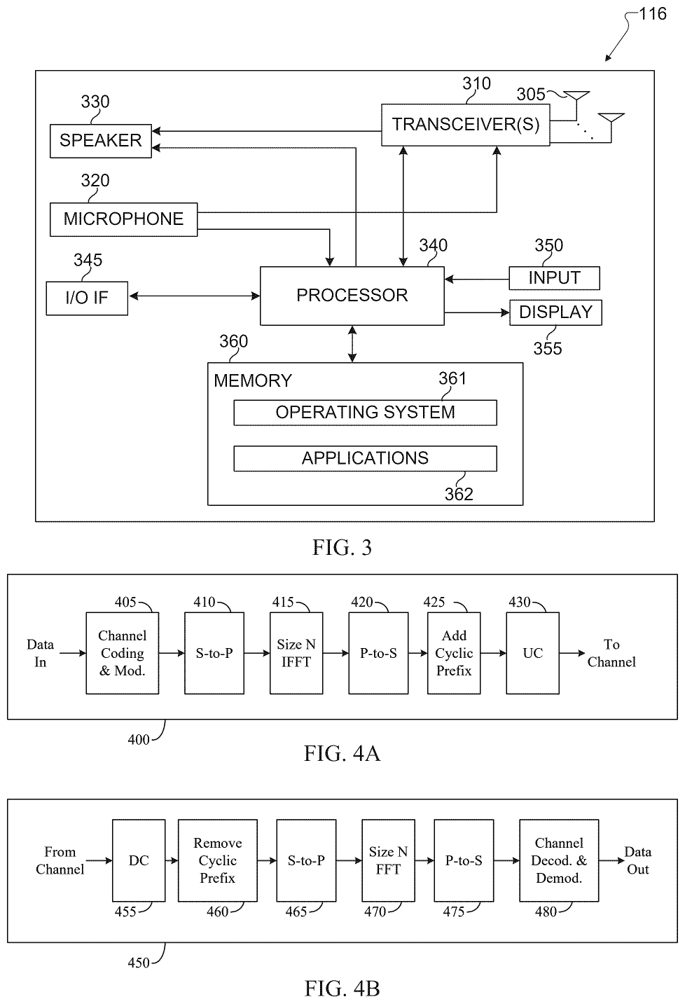

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identifying a SS/PBCH block structure(s) and receiving the SS/PBCH base thereon as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to transmit or receive a SS/PBCH block according to a SS/PBCH block structure(s) as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

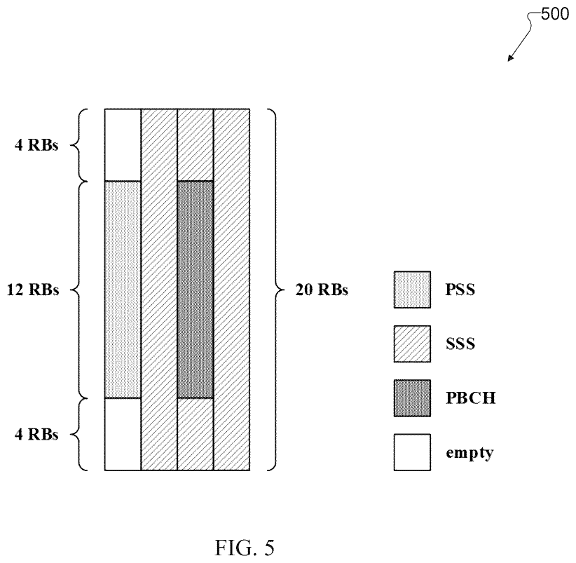

FIG. 5 illustrates an example SS/PBCH block architecture 500 according to embodiments of the present disclosure. For example, SS/PBCH block architecture 500 can be utilized by any of the UEs 111-116 of FIG. 1. This example is for illustration only and other embodiments can be used without departing from the scope of the present disclosure.

In NR Rel-15, each SS/PBCH block compromises of four consecutive OFDM symbols, wherein the center 12 resource blocks (RBs) of the first symbol are mapped for PSS, the second and forth symbols ae mapped for PBCH, and the third symbol is mapped for both SSS and PBCH. An illustration of the SS/PBCH block composition is shown in FIG. 5. The same SS/PBCH composition is applied to supported carrier frequency ranges in NR, which spans from 0.41 GHz to 7.125 GHz as Frequency Range 1 (FR1), and spans from 24.25 to 52.6 GHz as Frequency Range 2 (FR2). In every RB mapped for PBCH, 3 out of the 12 resource elements (REs) are mapped for the demodulation reference signal (DM-RS) of PBCH, wherein the 3 REs are uniformly distributed in the RB and the starting location of the first RE is based on cell identity (ID).

Embodiments of the present disclosure recognize that, for new generation of wireless communication to save the energy of a base station, the one shot detection performance for SS/PBCH block can be enhanced and the time and frequency domain structure for SS/PBCH block can be enhanced accordingly.

This disclosure provides for a SS/PBCH block structure. In various embodiments, the following aspects are included in the disclosure:
SSB Structure with 14 symbols
SSB Structure with 13 symbols
SSB Structure with 12 symbols
SSB Structure with 11 symbols
Example UE procedure

In one embodiment, one slot can include at least one SSB including at least synchronization signal(s). The SSB can also be multiplexed with a physical broadcast channel (PBCH).

For one example, a SSB can include N_{symb} OFDM symbols in the time domain. The N_{symb} OFDM symbols of the SSB can be indexed from 0 to N_{symb}−1. For one instance, the N_{symb} OFDM symbols can be consecutive in the time domain. For another instance, the N_{symb} OFDM symbols can be consecutive downlink OFDM symbols in the time domain.
Within the N_{symb} OFDM symbols of the SSB, N₁ number of the OFDM symbols are mapped for a first type of signal(s)/channel(s), and the set of indexes of the N₁ number of the OFDM symbols can be denoted as S₁.
Within the N_{symb} OFDM symbols of the SSB, N₂ number of the OFDM symbols are mapped for a second type of signal(s)/channel(s), and the set of indexes of the N₂ number of the OFDM symbols can be denoted as S₂.
Within the N_{symb} OFDM symbols of the SSB, N₃ number of the OFDM symbols are mapped for a third type of signal(s)/channel(s), and the set of indexes of the N₃ number of the OFDM symbols can be denoted as S₃.

In one example, the OFDM symbol for the first type of signal(s)/channel(s) can at least include a primary synchronization signal (PSS).
For one sub-example, the bandwidth of the OFDM symbol can be N_{RB} RBs (e.g., 12·N_{RB} subcarriers), and a sequence for PSS is mapped to the center 127 subcarriers within the 12·N_{RB} subcarriers (e.g., mapped to subcarrier #(12·N_{RB}−127−1)/2 to #(12·N_{RB}+127−3)/2), with the remaining subcarriers as empty.
For another sub-example, the bandwidth of the OFDM symbol can be N_{RB} RBs (e.g., 12·N_{RB} subcarriers), and a sequence for PSS is mapped to the center 127 subcarriers within the center 12 RBs within the N_{RB} RBs (e.g., mapped to subcarrier #(12·N_{RB}−127−1)/2 to #(12·N_{RB}+127−3)/2), with the remaining RBs mapped for PBCH.

In another example, the OFDM symbol for the second type of signal(s)/channel(s) can at least include a SSS.
For one sub-example, the bandwidth of the OFDM symbol can be N_{RB} RBs (e.g., 12·N_{RB} subcarriers), and a sequence for SSS is mapped to the center 127 subcarriers within the 12·N_{RB} subcarriers (e.g., mapped to subcarrier #(12·N_{RB}−127−1)/2 to #(12·N_{RB}+127-3)/2), with the remaining subcarriers as empty.
For another sub-example, the bandwidth of the OFDM symbol can be N_{RB} RBs (e.g., 12·N_{RB} subcarriers), and a sequence for SSS is mapped to the center 127 subcarriers within the center 12 RBs within the N_{RB} RBs (e.g., mapped to subcarrier #(12·N_{RB}−127-1)/2 to #(12·N_{RB}+127−3)/2), with the remaining RBs mapped for PBCH.

In yet another example, the OFDM symbol for the third type of signal(s)/channel(s) can at least include a PBCH, e.g., including a demodulation reference signal (DM-RS) of the PBCH, if supported.
For one sub-example, the bandwidth of the OFDM symbol can be N_{RB} RBs (e.g., 12·N_{RB} subcarriers).

For one example, N_{RB} can be pre-determined, e.g., as 11, or as 12, or as 18, or as 20, or as 22, or as 24. For one further evaluation, at least for the UE performing an initial cell search procedure.

For another example, N_{RB} can be configured by the base station, e.g., using higher layer parameter.

For yet another example, N_{RB} can be indicated by the base station, e.g., using control information.

For one example, N_{symb} can be pre-determined, e.g., according to one example of this disclosure. For one further evaluation, at least for the UE performing an initial cell search procedure.

For another example, N_{symb} can be configured by the base station, e.g., using higher layer parameter.

For yet another example, N_{symb} can be indicated by the base station, e.g., using control information.

For one example, the SSB structure can be pre-determined, e.g., according to one example of this disclosure. For instance, the SSB structure can be determined based on at least one of N_{symb}, Or N_{RB}, or S₁, or S₂, or S₃.

For another example, the SSB structure can be configured by the base station. For one instance, at least one of N_{symb}, Or N_{RB}, or S₁, or S₂, or S₃ can be provided by a higher layer parameter. For another instance, at least one of the example SSB structure in the disclosure can be configured by the base station.

For another example, the SSB structure can be indicated by the base station. For one instance, at least one of N_{symb}, or N_{RB}, or S₁, or S₂, or S₃ can be indicated by control information. For another instance, at least one of the example SSB structure in the disclosure can be indicated by control information.

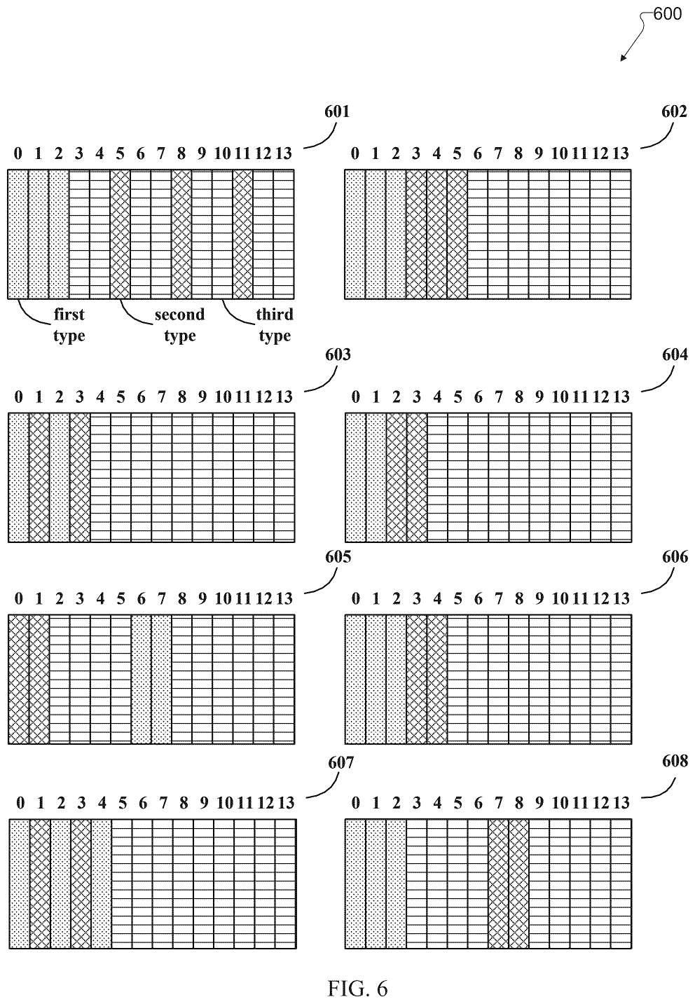

FIG. 6 illustrates diagrams of example SSB architectures 600 according to embodiments of the present disclosure. For example, SSB architectures 600 can be received by any of the UEs 111-116 of FIG. 1. This example is for illustration only and other embodiments can be used without departing from the scope of the present disclosure.

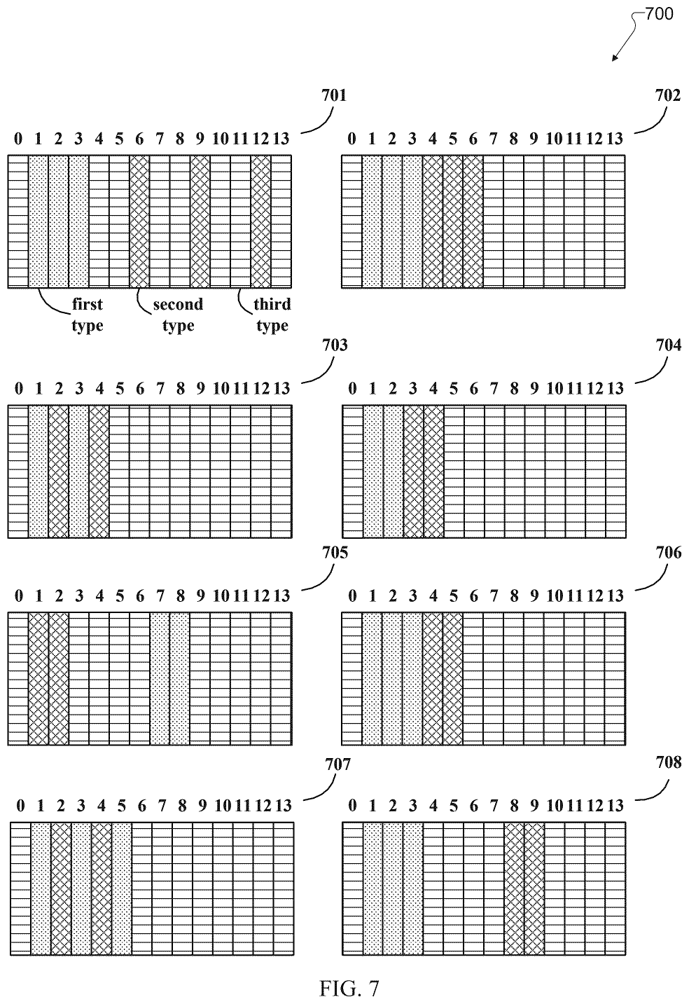

FIG. 7 illustrates diagrams of example SSB architectures 700 according to embodiments of the present disclosure. For example, SSB architectures 700 can be received by any of the UEs 111-116 of FIG. 1, such as the UE 111. This example is for illustration only and other embodiments can be used without departing from the scope of the present disclosure.

In one sub-embodiment, N_{symb}=14.

For a first example (e.g., 601 in FIG. 6) of this sub-embodiment, N₁=3, S₁={0, 1, 2}, N₂=3, S₂={5, 8, 11}, N₃=8, S₃={3, 4, 6, 7, 9, 10, 12, 13}.

For a second example (e.g., 602 in FIG. 6) of this sub-embodiment, N₁=3, S₁={0, 1, 2}, N₂=3, S₂={3, 4, 5}, N₃=8, S₃={6, 7, 8, 9, 10, 11, 12, 13}.

For a third example (e.g., 603 in FIG. 6) of this sub-embodiment, N₁=2, S₁={0, 2}, N₂=2, S₂={1,3}, N₃=10, S₃={4, 5, 6, 7, 8, 9, 10, 11, 12, 13}.

For a fourth example (e.g., 604 in FIG. 6) of this sub-embodiment, N₁=2, S₁={0, 1}, N₂=2, 52={2, 3}, N₃=10, 53={4, 5, 6, 7, 8, 9, 10, 11, 12, 13}.

For a fifth example (e.g., 605 in FIG. 6) of this sub-embodiment, N₁=2, S₁={6, 7}, N₂=2, S₂={0, 1}, N₃=10, S₃={2, 3, 4, 5, 8, 9, 10, 11, 12, 13}.

For a sixth example (e.g., 606 in FIG. 6) of this sub-embodiment, N₁=3, S₁={0, 1, 2}, N₂=2, S₂={3, 4}, N₃=9, 53={5, 6, 7, 8, 9, 10, 11, 12, 13}.

For a seventh example (e.g., 607 in FIG. 6) of this sub-embodiment, N₁=3, S₁={0, 2, 4}, N₂=2, S₂={1, 3}, N₃=9, S₃={5, 6, 7, 8, 9, 10, 11, 12, 13}.

For a eighth example (e.g., 608 in FIG. 6) of this sub-embodiment, N₁=3, S₁={0, 1, 2}, N₂=2, S₂={7, 8}, N₃=9, S₃={3, 4, 5, 6, 9, 10, 11, 12, 13}.

For a ninth example (e.g., 701 in FIG. 7) of this sub-embodiment, N₁=3, S₁={1, 2, 3}, N₂=3, 52={6, 9, 12}, N₃=8, 53={0, 4, 5, 7, 8, 10, 11, 13}.

For a tenth example (e.g., 702 in FIG. 7) of this sub-embodiment, N₁=3, S₁={1, 2, 3}, N₂=3, S₂={4, 5, 6}, N₃=8, S₃={0, 7, 8, 9, 10, 11, 12, 13}.

For an eleventh example (e.g., 703 in FIG. 7) of this sub-embodiment, N₁=2, S₁={1, 3}, N₂=2, S₂={2, 4}, N₃=10, S₃={0, 5, 6, 7, 8, 9, 10, 11, 12, 13}.

For a twelfth example (e.g., 704 in FIG. 7) of this sub-embodiment, N₁=2, S₁={1, 2}, N₂=2, S₂={3, 4}, N₃=10, S₃={0, 5, 6, 7, 8, 9, 10, 11, 12, 13}.

For a thirteenth example (e.g., 705 in FIG. 7) of this sub-embodiment, N₁=2, S₁={7, 8}, N₂=2, S₂={1, 2}, N₃=10, 53={0, 3, 4, 5, 6, 9, 10, 11, 12, 13}.

For a fourteenth example (e.g., 706 in FIG. 7) of this sub-embodiment, N₁=3, S₁={1, 2, 3}, N₂=2, S₂={4, 5}, N₃=9, S₃={0, 6, 7, 8, 9, 10, 11, 12, 13}.

For a fifteenth example (e.g., 707 in FIG. 7) of this sub-embodiment, N₁=3, S₁={1, 3, 5}, N₂=2, S₂={2, 4}, N₃=9, S₃={0, 6, 7, 8, 9, 10, 11, 12, 13}.

For a sixteenth example (e.g., 708 in FIG. 7) of this sub-embodiment, N₁=3, S₁={1, 2, 3}, N₂=2, S₂={8, 9}, N₃=9, S₃={0, 4, 5, 6, 7, 10, 11, 12, 13}.

In one further evaluation for the examples of this sub-embodiment, the SSB with 14 OFDM symbols can be mapped from a first OFDM symbol in a slot, e.g., #0 of the SSB is aligned with #0 of a slot. For one instance, the mapping can be applicable for all slots including the SSB.

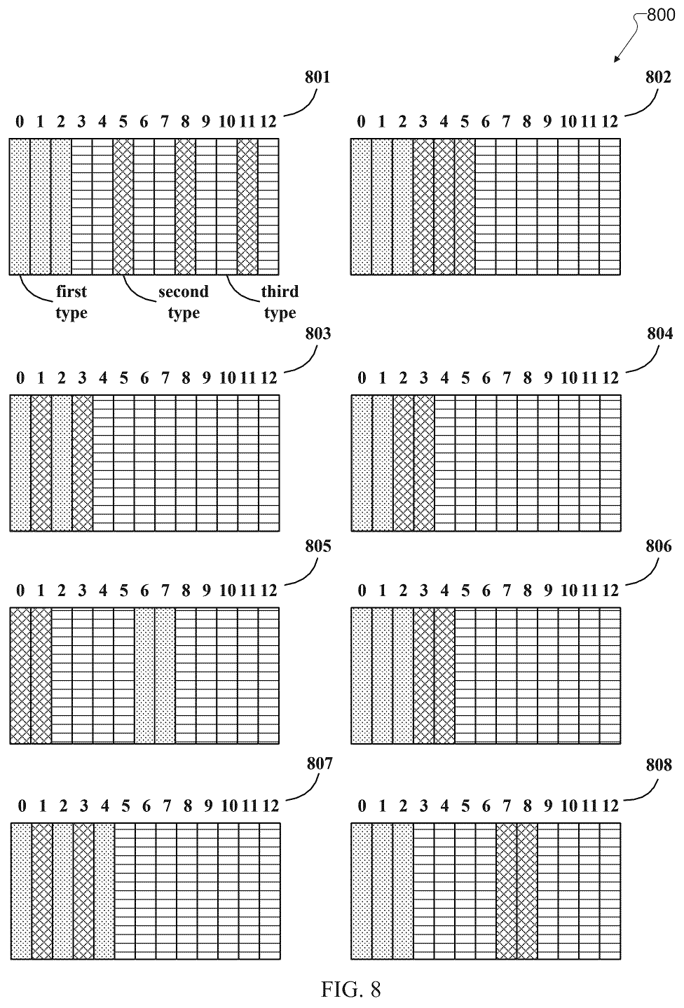

FIG. 8 illustrates diagrams of example SSB architectures 800 according to embodiments of the present disclosure. For example, SSB architectures 800 can be received by any of the UEs 111-116 of FIG. 1, such as the UE 112. This example is for illustration only and other embodiments can be used without departing from the scope of the present disclosure.

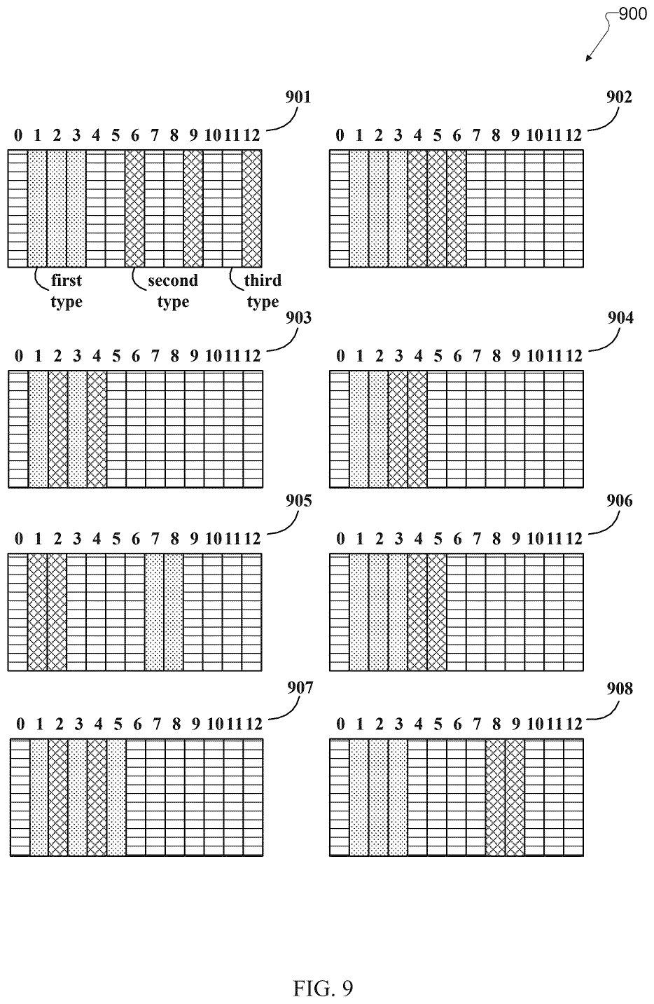

FIG. 9 illustrates diagrams of example SSB architectures 900 according to embodiments of the present disclosure. For example, SSB architectures 900 can be utilized by any of the UEs 111-116 of FIG. 1, such as the UE 113. This example is for illustration only and other embodiments can be used without departing from the scope of the present disclosure. In one sub-embodiment, N_{symb}=13.

For a first example (e.g., 801 in FIG. 8) of this sub-embodiment, N₁=3, S₁={0, 1, 2}, N₂=3, S₂={5, 8, 11}, N₃=7, S₃={3, 4, 6, 7, 9, 10, 12}.

For a second example (e.g., 802 in FIG. 8) of this sub-embodiment, N₁=3, S₁={0, 1, 2}, N₂=3, S₂={3, 4, 5}, N₃=7, S₃={6, 7, 8, 9, 10, 11, 12}.

For a third example (e.g., 803 in FIG. 8) of this sub-embodiment, N₁=2, S₁={0, 2}, N₂=2, S₂={1,3}, N₃=9, S₃={4, 5, 6, 7, 8, 9, 10, 11, 12}.

For a fourth example (e.g., 804 in FIG. 8) of this sub-embodiment, N₁=2, S₁={0, 1}, N₂=2, S₂={2, 3}, N₃=9, S₃={4, 5, 6, 7, 8, 9, 10, 11, 12}.

For a fifth example (e.g., 805 in FIG. 8) of this sub-embodiment, N₁=2, S₁={6, 7}, N₂=2, S₂={0, 1}, N₃=9, S₃={2, 3, 4, 5, 8, 9, 10, 11, 12}.

For a sixth example (e.g., 806 in FIG. 8) of this sub-embodiment, N₁=3, S₁={0, 1, 2}, N₂=2, S₂={3, 4}, N₃=8, S₃={5, 6, 7, 8, 9, 10, 11, 12}.

For a seventh example (e.g., 807 in FIG. 8) of this sub-embodiment, N₁=3, S₁={0, 2, 4}, N₂=2, S₂={1, 3}, N₃=8, S₃={5, 6, 7, 8, 9, 10, 11, 12}.

For a eighth example (e.g., 808 in FIG. 8) of this sub-embodiment, N₁=3, S₁={0, 1, 2}, N₂=2, 52={7, 8}, N₃=8, 53={3, 4, 5, 6, 9, 10, 11, 12}.

For a ninth example (e.g., 901 in FIG. 9) of this sub-embodiment, N₁=3, S₁={1, 2, 3}, N₂=3, S₂={6, 9, 12}, N₃=7, S₃={0, 4, 5, 7, 8, 10, 11}.

For a tenth example (e.g., 902 in FIG. 9) of this sub-embodiment, N₁=3, S₁={1, 2, 3}, N₂=3, S₂={4, 5, 6}, N₃=7, S₃={0, 7, 8, 9, 10, 11, 12}.

For a eleventh example (e.g., 903 in FIG. 9) of this sub-embodiment, N₁=2, S₁={1, 3}, N₂=2, S₂={2, 4}, N₃=9, S₃={0, 5, 6, 7, 8, 9, 10, 11, 12}.

For a twelfth example (e.g., 904 in FIG. 9) of this sub-embodiment, N₁=2, S₁={1, 2}, N₂=2, S₂={3, 4}, N₃=9, 53={0, 5, 6, 7, 8, 9, 10, 11, 12}.

For a thirteenth example (e.g., 905 in FIG. 9) of this sub-embodiment, N₁=2, S₁={7, 8}, N₂=2, S₂={1, 2}, N₃=9, S₃={0, 3, 4, 5, 6, 9, 10, 11, 12}.

For a fourteenth example (e.g., 906 in FIG. 9) of this sub-embodiment, N₁=3, S₁={1, 2, 3}, N₂=2, S₂={4, 5}, N₃=8, S₃={0, 6, 7, 8, 9, 10, 11, 12}.

For a fifteenth example (e.g., 907 in FIG. 9) of this sub-embodiment, N₁=3, S₁={1, 3, 5}, N₂=2, S₂={2, 4}, N₃=8, S₃={0, 6, 7, 8, 9, 10, 11, 12}.

For a sixteenth example (e.g., 908 in FIG. 9) of this sub-embodiment, N₁=3, S₁={1, 2, 3}, N₂=2, S₂={8, 9}, N₃=8, S₃={0, 4, 5, 6, 7, 10, 11, 12}.

In one further evaluation for the examples of this sub-embodiment, the SSB with 13 OFDM symbols can be mapped from a first OFDM symbol within a slot, e.g., #0 of the SSB is aligned with #0 of a slot. The remaining one symbol of this slot can be mapped for a CORESET and/or a hybrid automatic repeat request acknowledgement (HARQ-ACK) feedback. For one instance, the mapping can be applicable for all slots including the SSB.

In another further evaluation for the examples of this sub-embodiment, the SSB with 13 OFDM symbols can be mapped from a second OFDM symbol within a slot, e.g., #0 of the SSB is aligned with #1 of a slot. The remaining one symbol of this slot can be mapped for a CORESET and/or a HARQ-ACK feedback. For one instance, the mapping can be applicable for all slots including the SSB.

In yet another further evaluation for the examples of this sub-embodiment, the OFDM symbol that is used as a first OFDM symbol of the SSB with 13 OFDM symbols configured by the base station. For instance, the candidate value can be from {0, 1}. The remaining one symbol of this slot can be mapped for a CORESET and/or a HARQ-ACK feedback. For one instance, the mapping can be applicable for all slots including the SSB.

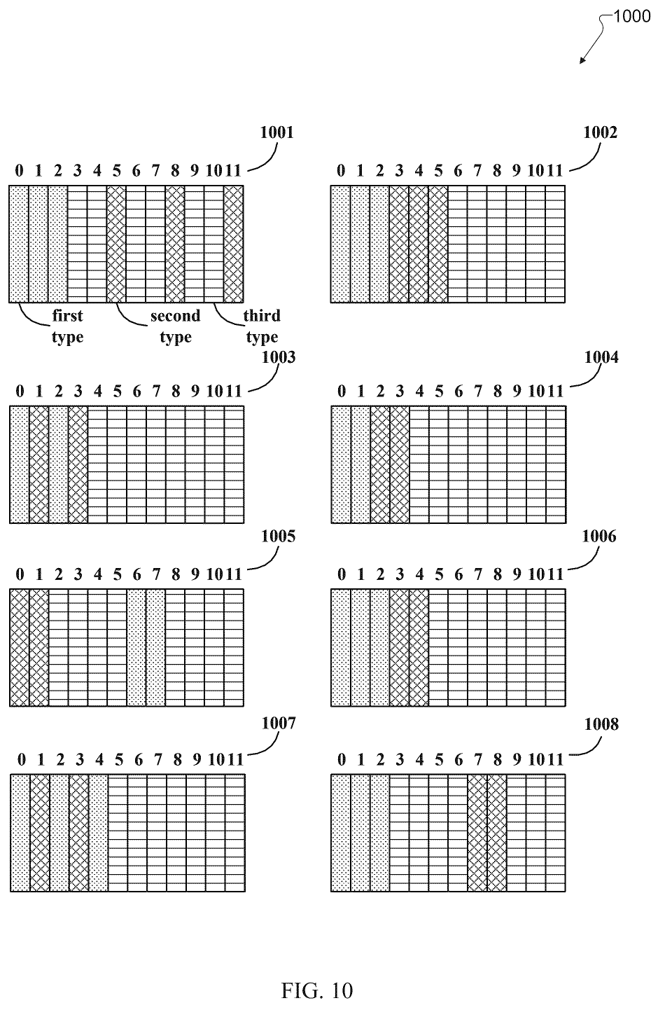

FIG. 10 illustrates diagrams of example SSB architectures 1000 according to embodiments of the present disclosure. For example, SSB architectures 1000 can be utilized by any of the UEs 111-116 of FIG. 1, such as the UE 114. This example is for illustration only and other embodiments can be used without departing from the scope of the present disclosure.

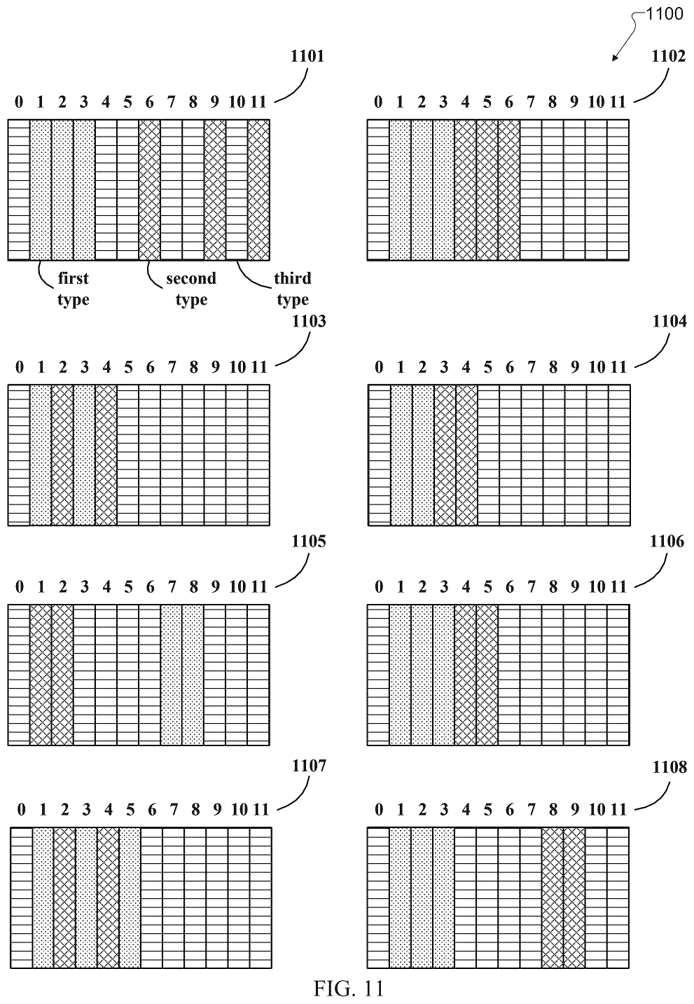

FIG. 11 illustrates diagrams of example SSB architectures 1100 according to embodiments of the present disclosure. For example, SSB architectures 1100 can be utilized by any of the UEs 111-116 of FIG. 1, such as the UE 115. This example is for illustration only and other embodiments can be used without departing from the scope of the present disclosure. In one sub-embodiment, N_{symb}=12.

For a first example (e.g., 1001 in FIG. 10) of this sub-embodiment, N₁=3, S₁={0, 1, 2}, N₂=3, S₂={5, 8, 11}, N₃=6, S₃={3, 4, 6, 7, 9, 10}.

For a second example (e.g., 1002 in FIG. 10) of this sub-embodiment, N₁=3, S₁={0, 1, 2}, N₂=3, S₂={3, 4, 5}, N₃=6, S₃={6, 7, 8, 9, 10, 11}.

For a third example (e.g., 1003 in FIG. 10) of this sub-embodiment, N₁=2, S₁={0, 2}, N₂=2, S₂={1,3}, N₃=8, S₃={4, 5, 6, 7, 8, 9, 10, 11}.

For a fourth example (e.g., 1004 in FIG. 10) of this sub-embodiment, N₁=2, S₁={0, 1}, N₂=2, S₂={2, 3}, N₃=8, 53={4, 5, 6, 7, 8, 9, 10, 11}.

For a fifth example (e.g., 1005 in FIG. 10) of this sub-embodiment, N₁=2, S₁={6, 7}, N₂=2, S₂={0, 1}, N₃=8, S₃={2, 3, 4, 5, 8, 9, 10, 11}.

For a sixth example (e.g., 1006 in FIG. 10) of this sub-embodiment, N₁=3, S₁={0, 1, 2}, N₂=2, S₂={3, 4}, N₃=7, S₃={5, 6, 7, 8, 9, 10, 11}.

For a seventh example (e.g., 1007 in FIG. 10) of this sub-embodiment, N₁=3, S₁={0, 2, 4}, N₂=2, S₂={1, 3}, N₃=7, S₃={5, 6, 7, 8, 9, 10, 11}.

For a eighth example (e.g., 1008 in FIG. 10) of this sub-embodiment, N₁=3, S₁={0, 1, 2}, N₂=2, S₂={7, 8}, N₃=7, 53={3, 4, 5, 6, 9, 10, 11}.

For a ninth example (e.g., 1101 in FIG. 11) of this sub-embodiment, N₁=3, S₁={1, 2, 3}, N₂=3, S₂={6, 9, 11}, N₃=6, S₃={0, 4, 5, 7, 8, 10}.

For a tenth example (e.g., 1102 in FIG. 11) of this sub-embodiment, N₁=3, S₁={1, 2, 3}, N₂=3, S₂={4, 5, 6}, N₃=6, S₃={0, 7, 8, 9, 10, 11}.

For a eleventh example (e.g., 1103 in FIG. 11) of this sub-embodiment, N₁=2, S₁={1, 3}, N₂=2, S₂={2, 4}, N₃-8, S₃={0, 5, 6, 7, 8, 9, 10, 11}.

For a twelfth example (e.g., 1104 in FIG. 11) of this sub-embodiment, N₁=2, S₁={1, 2}, N₂=2, S₂={3, 4}, N₃=8, 53={0, 5, 6, 7, 8, 9, 10, 11}.

For a thirteenth example (e.g., 1105 in FIG. 11) of this sub-embodiment, N₁=2, S₁={7, 8}, N₂=2, S₂={1, 2}, N₃=8, S₃={0, 3, 4, 5, 6, 9, 10, 11}.

For a fourteenth example (e.g., 1106 in FIG. 11) of this sub-embodiment, N₁=3, S₁={1, 2, 3}, N₂=2, 52={4, 5}, N₃=7, 53={0, 6, 7, 8, 9, 10, 11}.

For a fifteenth example (e.g., 1107 in FIG. 11) of this sub-embodiment, N₁=3, S₁={1, 3, 5}, N₂=2, S₂={2, 4}, N₃=7, S₃={0, 6, 7, 8, 9, 10, 11}.

For a sixteenth example (e.g., 1108 in FIG. 11) of this sub-embodiment, N₁=3, S₁={1, 2, 3}, N₂=2, S₂={8, 9}, N₃=7, 53={0, 4, 5, 6, 7, 10, 11}.

In one further evaluation for the examples of this sub-embodiment, the SSB with 12 OFDM symbols can be mapped from a first OFDM symbol within a slot, e.g., #0 of the SSB is aligned with #0 of a slot. The remaining two symbols of this slot can be mapped for a CORESET and/or a HARQ-ACK feedback. For one instance, the mapping can be applicable for all slots including the SSB.

In another further evaluation for the examples of this sub-embodiment, the SSB with 12 OFDM symbols can be mapped from a second OFDM symbol within a slot, e.g., #0 of the SSB is aligned with #1 of a slot. The remaining two symbols of this slot can be mapped for a CORESET and/or a HARQ-ACK feedback. For one instance, the mapping can be applicable for all slots including the SSB.

In yet another further evaluation for the examples of this sub-embodiment, the SSB with 12 OFDM symbols can be mapped from a second OFDM symbol within a slot, e.g., #0 of the SSB is aligned with #2 of a slot. The remaining two symbols of this slot can be mapped for a CORESET and/or a HARQ-ACK feedback. For one instance, the mapping can be applicable for all slots including the SSB.

In yet another further evaluation for the examples of this sub-embodiment, the OFDM symbol that is used as a first OFDM symbol of the SSB with 12 OFDM symbols configured by the base station. For instance, the candidate value can be from {0, 1, 2} or its subset. The remaining two symbols of this slot can be mapped for a CORESET and/or a HARQ-ACK feedback. For one instance, the mapping can be applicable for all slots including the SSB.

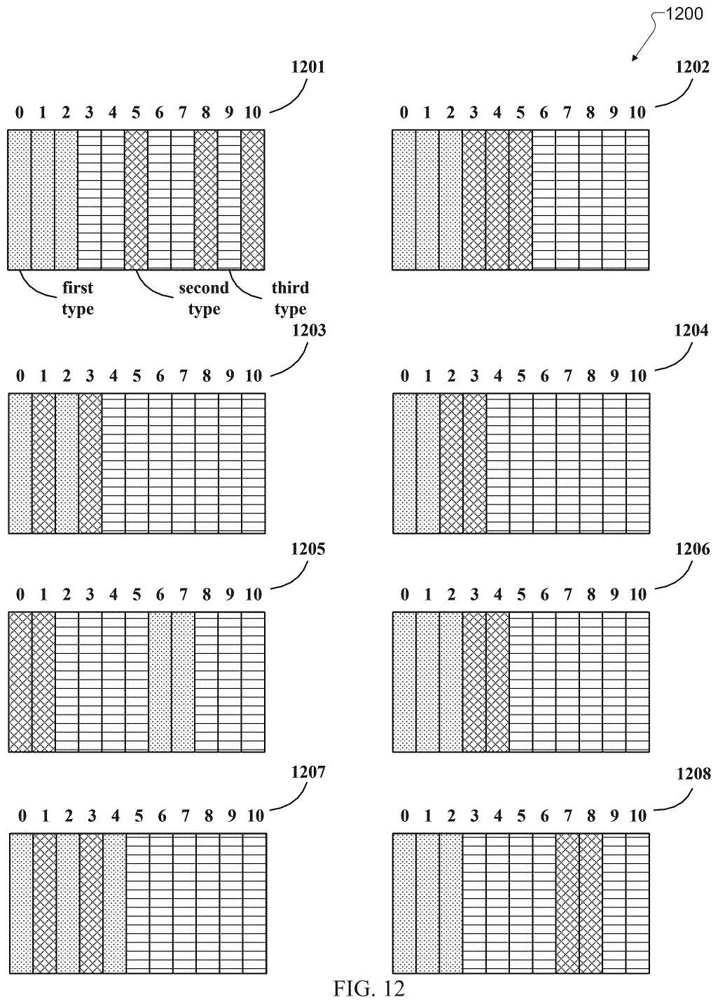

FIG. 12 illustrates diagrams of example SSB architectures 1200 according to embodiments of the present disclosure. For example, SSB architectures 1200 can be utilized by any of the UEs 111-116 of FIG. 1, such as the UE 116. This example is for illustration only and other embodiments can be used without departing from the scope of the present disclosure.

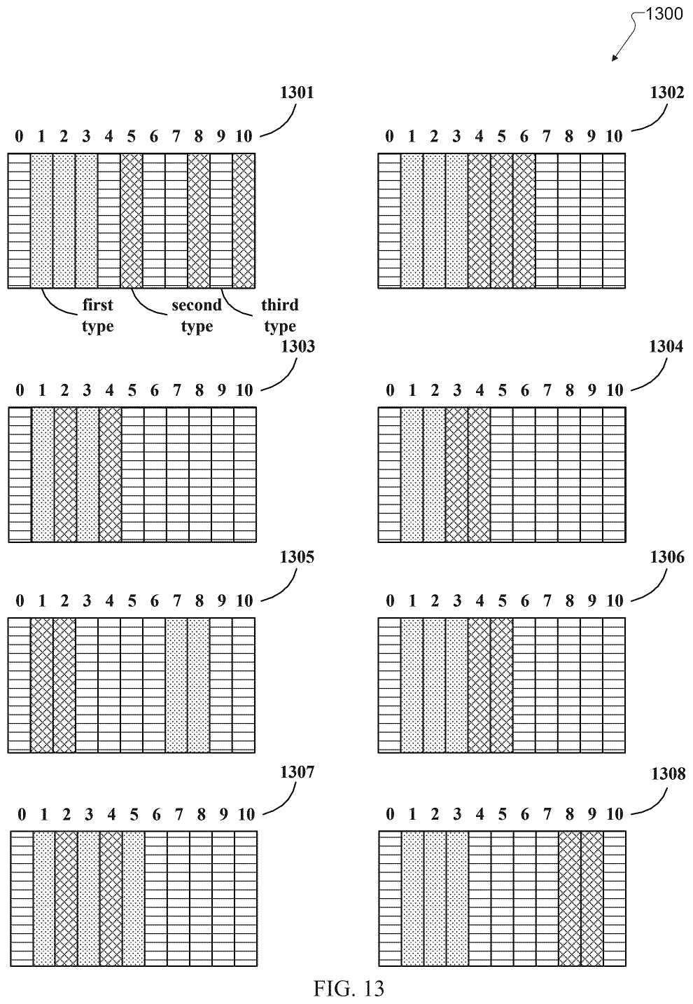

FIG. 13 illustrates diagrams of example SSB architectures 1300 according to embodiments of the present disclosure. For example, SSB architectures 1300 can be utilized by the UE 116 of FIG. 3. This example is for illustration only and other embodiments can be used without departing from the scope of the present disclosure.

In one sub-embodiment, N_{symb}=11.

For a first example (e.g., 1201 in FIG. 12) of this sub-embodiment, N₁=3, S₁={0, 1, 2}, N₂=3, 52={5, 8, 10}, N₃=5, S₃={3, 4, 6, 7, 9}.

For a second example (e.g., 1202 in FIG. 12) of this sub-embodiment, N₁=3, S₁={0, 1, 2}, N₂=3, S₂={3, 4, 5}, N₃=5, 53={6, 7, 8, 9, 10}.

For a third example (e.g., 1203 in FIG. 12) of this sub-embodiment, N₁=2, S₁={0, 2}, N₂=2, S₂={1,3}, N₃=7, S₃={4, 5, 6, 7, 8, 9, 10}.

For a fourth example (e.g., 1204 in FIG. 12) of this sub-embodiment, N₁=2, S₁={0, 1}, N₂=2, S₂={2, 3}, N₃=7, 53={4, 5, 6, 7, 8, 9, 10}.

For a fifth example (e.g., 1205 in FIG. 12) of this sub-embodiment, N₁=2, S₁={6, 7}, N₂=2, S₂={0, 1}, N₃=7, S₃={2, 3, 4, 5, 8, 9, 10}.

For a sixth example (e.g., 1206 in FIG. 12) of this sub-embodiment, N₁=3, S₁={0, 1, 2}, N₂=2, 52={3, 4}, N₃=6, 53={5, 6, 7, 8, 9, 10}.

For a seventh example (e.g., 1207 in FIG. 12) of this sub-embodiment, N₁=3, S₁={0, 2, 4}, N₂=2, S₂={1, 3}, N₃=6, S₃={5, 6, 7, 8, 9, 10}.

For a eighth example (e.g., 1208 in FIG. 12) of this sub-embodiment, N₁=3, S₁={0, 1, 2}, N₂=2, S₂={7, 8}, N₃=6, 53={3, 4, 5, 6, 9, 10}.

For a ninth example (e.g., 1301 in FIG. 13) of this sub-embodiment, N₁=3, S₁={1, 2, 3}, N₂=3, S₂={5, 8, 10}, N₃=5, S₃={0, 4, 6, 7, 9}.

For a tenth example (e.g., 1302 in FIG. 13) of this sub-embodiment, N₁=3, S₁={1, 2, 3}, N₂=3, S₂={4, 5, 6}, N₃=5, S₃={0, 7, 8, 9, 10}.

For a eleventh example (e.g., 1303 in FIG. 13) of this sub-embodiment, N₁=2, S₁={1, 3}, N₂=2, S₂={2, 4}, N₃=7, S₃={0, 5, 6, 7, 8, 9, 10}.

For a twelfth example (e.g., 1304 in FIG. 13) of this sub-embodiment, N₁=2, S₁={1, 2}, N₂=2, S₂={3, 4}, N₃=7, S₃={0, 5, 6, 7, 8, 9, 10}.

For a thirteenth example (e.g., 1305 in FIG. 13) of this sub-embodiment, N₁=2, S₁={7, 8}, N₂=2, 52={1, 2}, N₃=7, 53={0, 3, 4, 5, 6, 9, 10}.

For a fourteenth example (e.g., 1306 in FIG. 13) of this sub-embodiment, N₁=3, S₁={1, 2, 3}, N₂=2, S₂={4, 5}, N₃=6, S₃={0, 6, 7, 8, 9, 10}.

For a fifteenth example (e.g., 1307 in FIG. 13) of this sub-embodiment, N₁=3, S₁={1, 3, 5}, N₂=2, S₂={2, 4}, N₃=6, S₃={0, 6, 7, 8, 9, 10}.

For a sixteenth example (e.g., 1308 in FIG. 13) of this sub-embodiment, N₁=3, S₁={1, 2, 3}, N₂=2, S₂={8, 9}, N₃=6, S₃={0, 4, 5, 6, 7, 10}.

In one further evaluation for the examples of this sub-embodiment, the SSB with 11 OFDM symbols can be mapped from a first OFDM symbol within a slot, e.g., #0 of the SSB is aligned with #0 of a slot. The remaining three symbols of this slot can be mapped for a CORESET and/or a HARQ-ACK feedback. For one instance, the mapping can be applicable for all slots including the SSB.

In another further evaluation for the examples of this sub-embodiment, the SSB with 11 OFDM symbols can be mapped from a second OFDM symbol within a slot, e.g., #0 of the SSB is aligned with #1 of a slot. The remaining three symbols of this slot can be mapped for a CORESET and/or a HARQ-ACK feedback. For one instance, the mapping can be applicable for all slots including the SSB.

In yet another further evaluation for the examples of this sub-embodiment, the SSB with 11 OFDM symbols can be mapped from a second OFDM symbol within a slot, e.g., #0 of the SSB is aligned with #2 of a slot. The remaining three symbols of this slot can be mapped for a CORESET and/or a HARQ-ACK feedback. For one instance, the mapping can be applicable for all slots including the SSB.

In yet another further evaluation for the examples of this sub-embodiment, the SSB with 11 OFDM symbols can be mapped from a second OFDM symbol within a slot, e.g., #0 of the SSB is aligned with #3 of a slot. The remaining three symbols of this slot can be mapped for a CORESET and/or a HARQ-ACK feedback. For one instance, the mapping can be applicable for all slots including the SSB.

In yet another further evaluation for the examples of this sub-embodiment, the OFDM symbol that is used as a first OFDM symbol of the SSB with 11 OFDM symbols configured by the base station. For instance, the candidate value can be from {0, 1, 2, 3} or its subset. The remaining two symbols of this slot can be mapped for a CORESET and/or a HARQ-ACK feedback. For one instance, the mapping can be applicable for all slots including the SSB.

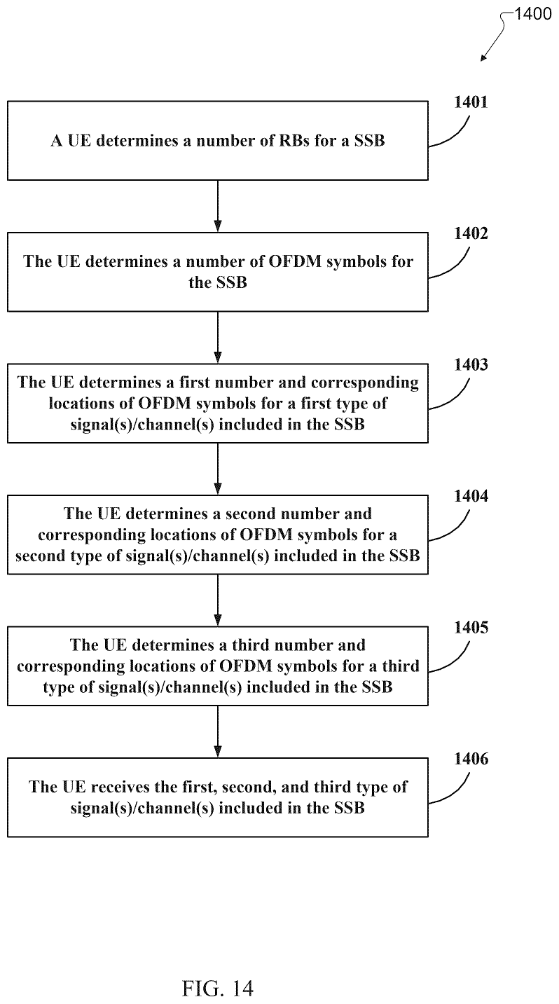

FIG. 14 illustrates a flowchart of an example UE procedure 1400 for receiving signal(s)/channel(s) according to embodiments of the present disclosure. For example, procedure 1400 can be performed by any of the UEs 111-116 of FIG. 1 and a corresponding or analogous process may be performed by the any of the BSs 101-103 of FIG. 1. This example is for illustration only and other embodiments can be used without departing from the scope of the present disclosure.

In one embodiment, an example UE procedure for receiving a SSB is shown in FIG. 14. The procedure begins in 1401, a UE determines a number of RBs for a SSB. In 1402, the UE determines a number of OFDM symbols for the SSB. In 1403, the UE determines a first number and corresponding locations of OFDM symbols for a first type of signal(s)/channel(s) included in the SSB. For example, the type of signal(s)/channel(s) may be PSS, SSS, or PBCH. In 1404, the UE determines a second number and corresponding locations of OFDM symbols for a second type of signal(s)/channel(s) included in the SSB. For example, the type of signal(s)/channel(s) may be PSS, SSS, or PBCH. In 1405, the UE determines a third number and corresponding locations of OFDM symbols for a third type of signal(s)/channel(s) included in the SSB. For example, the type of signal(s)/channel(s) may be PSS, SSS, or PBCH. In 1406, the UE receives the first, second, and third type of signal(s)/channel(s) included in the SSB.

This disclosure provides for a SS/PBCH block structure with large bandwidth, wherein signal(s) and/or channel(s) within the SS/PBCH block can be frequency division multiplexed (FDMed). In various embodiments, the following aspects are included in the disclosure:
SSB Structure with Short PSS/SSS
SSB Structure with Long PSS/SSS.
SSB Structure with Long PSS and Short SSS.
SSB Structure with Short PSS and Long SSS
Example UE procedure

In one embodiment, one slot can include at least one SSB. For one further evaluation, the SSB can also be multiplexed with PBCH.

For one example, a SSB can include N_{RB} RBs in the frequency domain. The N_{RB} RBs of the SSB can be indexed from 0 to N_{RB}−1.

For another example, a SSB can include N_{symb} OFDM symbols in the time domain. The N_{symb} OFDM symbols of the SSB can be indexed from 0 to N_{symb}−1.

The following notations are used for this embodiment:
N_{RB}: a number of RBs in the frequency domain of a SSB, i.e., the bandwidth of the OFDM symbol(s) of a SSB.
N_{symb}: a number of OFDM symbols in the time domain of a SSB.
N₁: a number of a first type of signal(s)/channel(s) within the SSB.
N₂: a number of a second type of signal(s)/channel(s) within the SSB.
N₃: a number of a third type of signal(s)/channel(s) within the SSB.
S₁: the set of indexes of a first type of signal(s)/channel(s) within the SSB. An index of a first type of signal(s)/channel(s) has two dimensions (e.g., denoted as (S_{1,t}, S_{1,f})), including a time domain index (e.g., s_{1,t}) denoting the OFDM symbol where the first type of signal(s)/channel(s) is mapped to, and a frequency domain index (e.g., s_{1,f}) denoting the lowest RB index where the first type of signal(s)/channel(s) is mapped from.
S₂: the set of indexes of a second type of signal(s)/channel(s) within the SSB. An index of a first type of signal(s)/channel(s) has two dimensions (e.g., denoted as (S_{2,t},S_{2,f})), including a time domain index (e.g., s_{2,t}) denoting the OFDM symbol where the first type of signal(s)/channel(s) is mapped to, and a frequency domain index (e.g., s_{2,f}) denoting the lowest RB index where the first type of signal(s)/channel(s) is mapped from S₃: the set of indexes of a third type of signal(s)/channel(s) within the SSB. An index of a first type of signal(s)/channel(s) has two dimensions (e.g., denoted as (S_{3,t}, S_{3,f})), including a time domain index (e.g., s_{3,t}) denoting the OFDM symbol where the first type of signal(s)/channel(s) is mapped to, and a frequency domain index (e.g., S_{3,f}) denoting the lowest RB index where the first type of signal(s)/channel(s) is mapped from.
L₁: a number of RBs in the frequency domain wherein a primary synchronization signal (PSS) is mapped.
L₂: a number of RBs in the frequency domain wherein a secondary synchronization signal (SSS) is mapped.

In one example, the OFDM symbol for the first type of signal(s)/channel(s) can at least include a primary synchronization signal (PSS).
For one sub-example, the bandwidth of the OFDM symbol can be N_{RB} RBs (e.g., 12·N_{RB} subcarriers), and a sequence for PSS is mapped to the center 127 subcarriers within the 12·N_{RB} subcarriers, with the remaining subcarriers as empty.
For another sub-example, the bandwidth of the OFDM symbol can be N_{RB} RBs (e.g., 12·N_{RB} subcarriers), and a sequence for PSS is mapped to the center 127 subcarriers within the center 12 RBs within the N_{RB} RBs, with the remaining RBs mapped for another signal or channel in the SSB, e.g., SSS or PBCH.
For yet another sub-example, the bandwidth of the OFDM symbol can be N_{RB} RBs (e.g., 12·N_{RB} subcarriers), and a sequence for PSS is mapped to the upper and/or lower 127 subcarriers within the 12·N_{RB} subcarriers, with the remaining subcarriers as empty.
For yet another sub-example, the bandwidth of the OFDM symbol can be N_{RB} RBs (e.g., 12·N_{RB} subcarriers), and a sequence for PSS is mapped to the upper and/or lower 127 subcarriers within the 12·N_{RB} subcarriers, with the remaining RBs mapped for another signal or channel in the SSB, e.g., SSS or PBCH.
For yet another sub-example, the bandwidth of the OFDM symbol can be N_{RB} RBs (e.g., 12·N_{RB} subcarriers), and a sequence for PSS is mapped to the center 255 subcarriers within the 12·N_{RB} subcarriers, with the remaining subcarriers as empty.
For yet another sub-example, the bandwidth of the OFDM symbol can be N_{RB} RBs (e.g., 12·N_{RB} subcarriers), and a sequence for PSS is mapped to the center 255 subcarriers within the 12·N_{RB} subcarriers, with the remaining RBs mapped for another signal or channel in the SSB, e.g., SSS or PBCH.

In another example, the OFDM symbol for the second type of signal(s)/channel(s) can at least include a SSS.
For one sub-example, the bandwidth of the OFDM symbol can be N_{RB} RBs (e.g., 12·N_{RB} subcarriers), and a sequence for SSS is mapped to the center 127 subcarriers within the 12·N_{RB} subcarriers, with the remaining subcarriers as empty.
For another sub-example, the bandwidth of the OFDM symbol can be N_{RB} RBs (e.g., 12·N_{RB} subcarriers), and a sequence for SSS is mapped to the center 127 subcarriers within the center 12 RBs within the N_{RB} RBs, with the remaining RBs mapped for another signal or channel in the SSB, e.g., PSS or PBCH.
For yet another sub-example, the bandwidth of the OFDM symbol can be N_{RB} RBs (e.g., 12·N_{RB} subcarriers), and a sequence for SSS is mapped to the upper and/or lower 127 subcarriers within the 12·N_{RB} subcarriers, with the remaining subcarriers as empty.
For yet another sub-example, the bandwidth of the OFDM symbol can be N_{RB} RBs (e.g., 12·N_{RB} subcarriers), and a sequence for SSS is mapped to the upper and/or lower 127 subcarriers within the 12·N_{RB} subcarriers, with the remaining RBs mapped for another signal or channel in the SSB, e.g., PSS or PBCH.
For yet another sub-example, the bandwidth of the OFDM symbol can be N_{RB} RBs (e.g., 12·N_{RB} subcarriers), and a sequence for SSS is mapped to the center 255 subcarriers within the 12·N_{RB} subcarriers, with the remaining subcarriers as empty.
For yet another sub-example, the bandwidth of the OFDM symbol can be N_{RB} RBs (e.g., 12·N_{RB} subcarriers), and a sequence for SSS is mapped to the center 255 subcarriers within the 12·N_{RB} subcarriers, with the remaining RBs mapped for another signal or channel in the SSB, e.g., PSS or PBCH.

In yet another example, the OFDM symbol for the third type of signal(s)/channel(s) can at least include a PBCH) e.g., including a demodulation reference signal (DM-RS) of the PBCH, if supported.
For one sub-example, the bandwidth of the OFDM symbol can be N_{RB} RBs (e.g., 12·N_{RB} subcarriers).
For yet another sub-example, the bandwidth of the OFDM symbol can be N_{RB} RBs (e.g., 24·N_{RB} subcarriers).

For one example, N_{RB} can be pre-determined, e.g., as 12, or as 18, or as 20, or as 24.

For another example, N_{RB} can be configured by the base station, e.g., using higher layer parameter.

For yet another example, N_{RB} can be indicated by the base station, e.g., using control information.

For one example, N_{symb} can be pre-determined, e.g., as 14, or as 13, or as 12, or as 11, or as 10, or as 9, or as 8, or as 7, or as 6, or as 5.

For another example, N_{symb} can be configured by the base station, e.g., using higher layer parameter.

For yet another example, N_{symb} can be indicated by the base station, e.g., using control information.

For one example, L₁ can be predefined based on the bandwidth of a SSB, e.g., L₁ can be predefined as 12 RBs (e.g., when N_{RB} is 12 and/or 24 RBs).

For another example, L₁ can be predefined as 24 RBs (e.g., when N_{RB} is 24 RBs).

For yet another example, L₁ can be predefined as 6 RBs.

For one example, L₂ can be predefined based on the bandwidth of a SSB, e.g., L₂ can be predefined as 12 RBs (e.g., when N_{RB} is 12 and/or 24 RBs).

For another example, L₂ can be predefined as 24 RBs (e.g., when N_{RB} is 24 RBs). For yet another example, L₂ can be predefined as 6 RBs.

For one example, the SSB structure can be pre-determined, e.g., according to one example of this disclosure. For instance, the SSB structure can be determined based on at least one of N_{symb}, Or N_{RB}, or S₁, or S₂, or S₃, or L₁, or L₂.

For another example, the SSB structure can be configured by the base station. For one instance, at least one of N_{symb}, Or N_{RB}, or S₁, or S₂, or S₃, or L₁, or L₂ can be provided by a higher layer parameter. For another instance, at least one of the example SSB structure in the disclosure can be configured by the base station.

For another example, the SSB structure can be indicated by the base station. For one instance, at least one of N_{symb}, Or N_{RB}, or S₁, or S₂, or S₃, or L₁, or L₂ can be indicated by control information. For another instance, at least one of the example SSB structure in the disclosure can be indicated by control information.

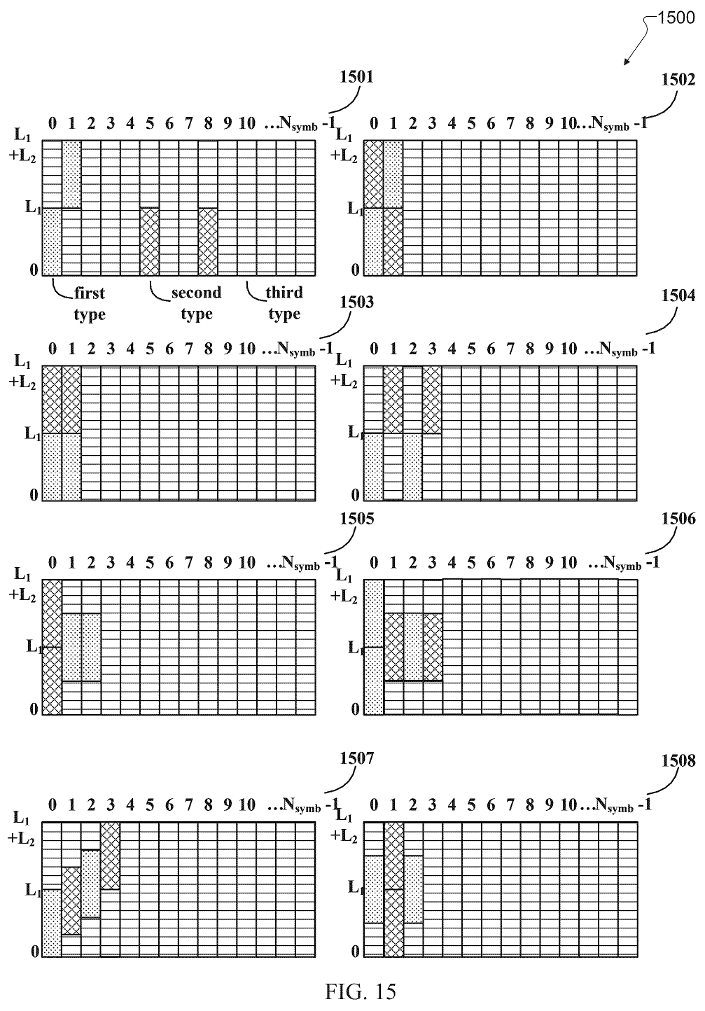

FIG. 15 illustrates diagrams of example SSB architectures 1500 according to embodiments of the present disclosure. For example, SSB architectures 1500 can be utilized by any of the UEs 111-116 of FIG. 1. This example is for illustration only and other embodiments can be used without departing from the scope of the present disclosure.

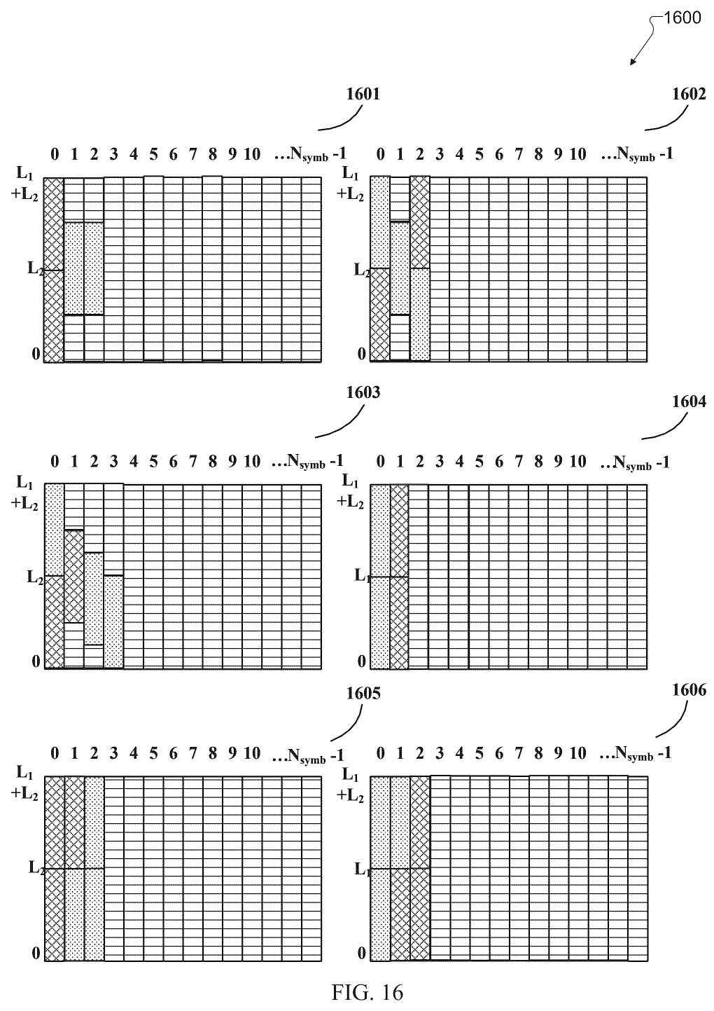

FIG. 16 illustrates diagrams of example SSB architectures 1600 according to embodiments of the present disclosure. For example, SSB architectures 1600 can be utilized by any of the UEs 111-116 of FIG. 1, such as the UE 111. This example is for illustration only and other embodiments can be used without departing from the scope of the present disclosure.

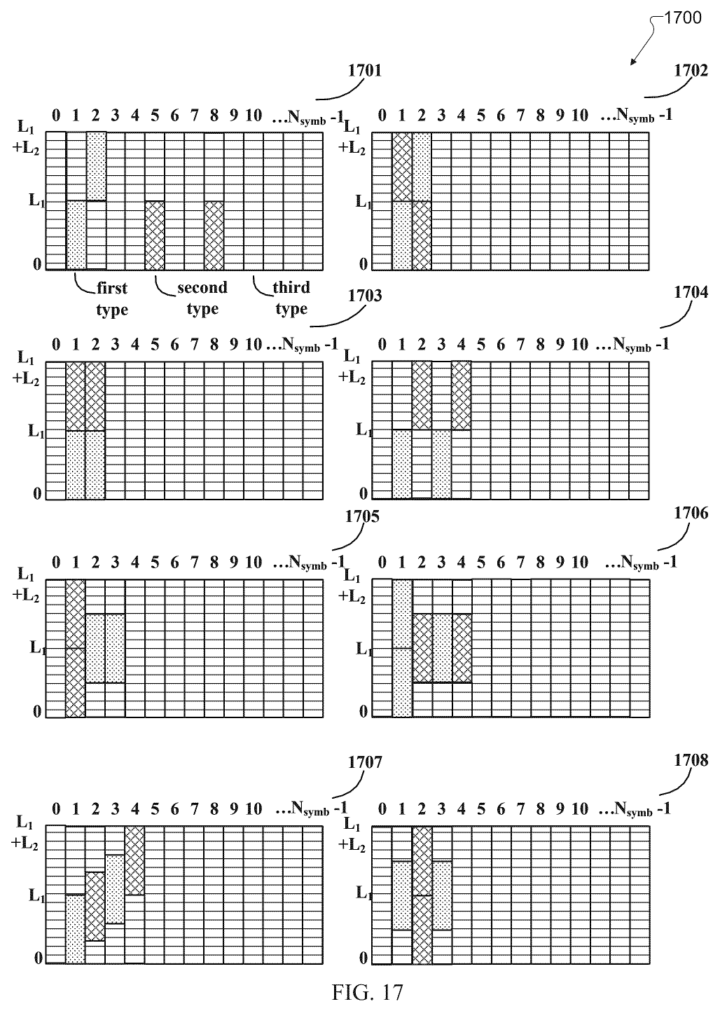

FIG. 17 illustrates diagrams of example SSB architectures 1700 according to embodiments of the present disclosure. For example, SSB architectures 1700 can be utilized by any of the UEs 111-116 of FIG. 1, such as the UE 112. This example is for illustration only and other embodiments can be used without departing from the scope of the present disclosure.

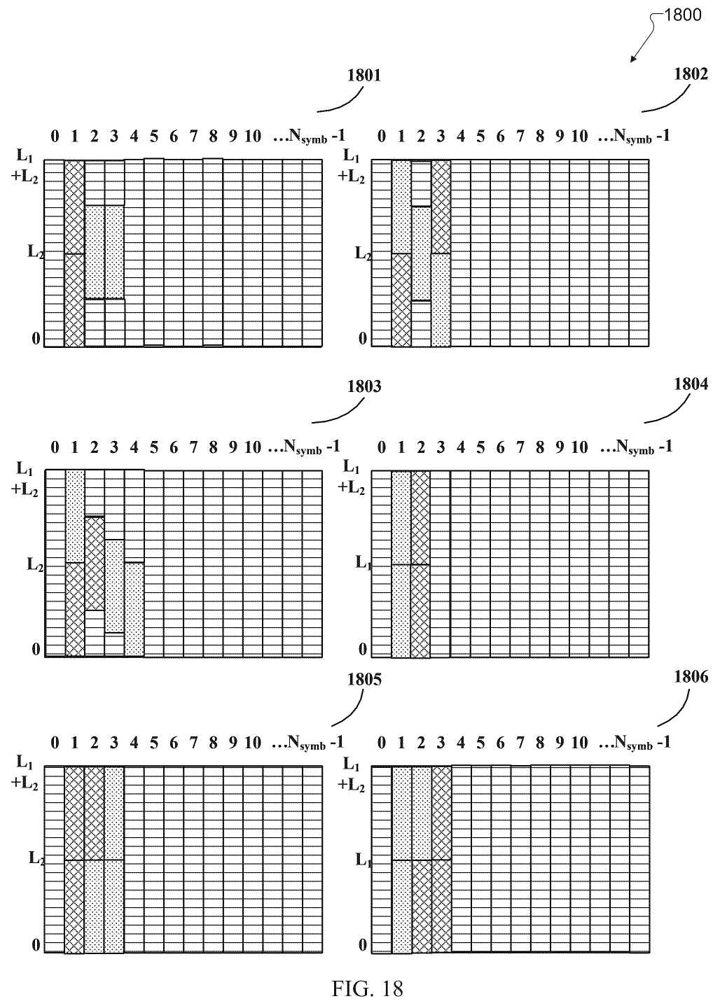

FIG. 18 illustrates diagrams of example SSB architectures 1800 according to embodiments of the present disclosure. For example, SSB architectures 1800 can be utilized by any of the UEs 111-116 of FIG. 1, such as the UE 113. This example is for illustration only and other embodiments can be used without departing from the scope of the present disclosure.

In one sub-embodiment, N_{RB}=L₁+L₂. For one example, L₁=12, and/or L₂=12. For another example, L₁=11, and/or L₂=11.

For a first example (e.g., 1501 in FIG. 15) of this sub-embodiment, N₁=2, S₁={(0, 0), (1, L₁)}, N₂=2, S₂={(5, 0), (8, 0)}, N₃=14, S₃={(0, L₁), (1, 0), (2, 0), (3, 0), (4, 0), (5, L₁), (6, 0), . . . , (N_{symb}−1, 0)}.

For a second example (e.g., 1502 in FIG. 15) of this sub-embodiment, N₁=2, S₁={(0, 0), (1, L₁)}, N₂=2, S₂={(0, L₁), (1, 0)}, N₃=12, S₃={(2, 0), (3, 0), (4, 0), (5, 0), (6, 0), . . . , (N_{symb}−1, 0)}.

For a third example (e.g., 1503 in FIG. 15) of this sub-embodiment, N₁=2, S₁={(0, 0), (1, 0)}, N₂=2, 52={(0, L₁), (1, L₁)}, N₃=12, S₃={(2, 0), (3, 0), (4, 0), (5, 0), (6, 0), . . . , (N_{symb}−1, 0)}.

For a fourth example (e.g., 1504 in FIG. 15) of this sub-embodiment, N₁=2, S₁={(0, 0), (2, 0)}, N₂=2, S₂={(1, L₁), (3, L₁)}, N₃=14, S₃={(0, L₁), (1, 0), (2, L₁), (3, 0), (4, 0), (5, 0), (6, 0), . . . , (N_{symb}−1, 0)}.

For a fifth example (e.g., 1505 in FIG. 15) of this sub-embodiment, N₁=2, S₁={(1, L₁/2), (2, L₁/2)}, N₂=2, S₂={(0,0), (0, L₁)}, N₃=15,53={(1, 0), (1, 3L₁/2), (2, 0), (2, 3L₁/2), (3, 0), (4, 0), (5, 0), (6, 0), . . . , (N_{symb}−1, 0)}.

For a sixth example (e.g., 1506 in FIG. 15) of this sub-embodiment,

$${N}_{1} = 3 , {S}_{1} = \{ ( 0 , ( 0 , {L}_{1} ) , ( 2 , {L}_{1} / 2 ) \} , {N}_{2} = 2 , {S}_{2} = \{ ( 1 , {L}_{1} / 2 ) , ( 3 , {L}_{1} / 2 ) \} , {N}_{3} = 16 , {S}_{3} = \{ ( 1 , 0 ) , ( 1 , \frac{{L}_{1}}{2} + {L}_{2} ) , ( 2 , 0 ) , ( 2 , \frac{3 {L}_{1}}{2} ) , ( 3 , 0 ) , ( 3 , \frac{{L}_{1}}{2} + {L}_{2} ) , ( 4 , 0 ) , ( 5 , 0 ) , ( 6 , 0 ) , … , ( {N}_{symb} - 1 , 0 ) \} .$$

For a seventh example (e.g., 1507 in FIG. 15) of this sub-embodiment,

$${N}_{1} = 2 , {S}_{1} = \{ ( 0 , 0 ) , ( 2 , {L}_{1} / 2 ) \} , {N}_{2} = 2 , {S}_{2} = \{ ( 1 , {L}_{1} / 2 ) , ( 3 , {L}_{1} ) \} , {N}_{3} = 16 , {S}_{3} = \{ ( 0 , {L}_{1} ) , ( 1 , 0 ) , ( 1 , \frac{{L}_{1}}{2} + {L}_{2} ) , ( 2 , 0 ) , ( \frac{3 {L}_{1}}{2} ) , ( 3 , 0 ) , ( 4 , 0 ) , ( 5 , 0 ) , ( 6 , 0 ) , … , ( {N}_{symb} - 1 , 0 ) \} .$$

For a eighth example (e.g., 1508 in FIG. 15) of this sub-embodiment,

$${N}_{1} = 2 , {S}_{1} = \{ ( 0 , {L}_{1} / 2 ) , ( 2 , {L}_{1} / 2 ) \} , {N}_{2} = 2 , {S}_{2} = \{ ( 1 , 0 ) , ( 1 , {L}_{2} / 2 ) \} , {N}_{3} = 15 , {S}_{3} = \{ ( 0 , 0 ) , ( 0 , \frac{3 {L}_{1}}{2} ) , ( 2 , 0 ) , ( 2 , \frac{3 {L}_{1}}{2} ) , ( 3 , 0 ) , ( 4 , 0 ) , ( 5 , 0 ) , ( 6 , 0 ) , … , ( {N}_{symb} - 1 , 0 ) \} .$$

For a ninth example (e.g., 1601 in FIG. 16) of this sub-embodiment,

$${N}_{1} = 2 , {S}_{1} = \{ ( 1 , {L}_{2} / 2 ) , ( 2 , {L}_{2} / 2 ) \} , {N}_{2} = 2 , {S}_{2} = \{ ( 0 , 0 ) , ( 0 , {L}_{1} ) \} , {N}_{3} = 15 , {S}_{3} = \{ ( 1 , 0 ) , ( 1 , \frac{{L}_{2}}{2} + {L}_{1} ) , ( 2 , 0 ) , ( 2 , \frac{{L}_{2}}{2} + {L}_{1} ) , ( 3 , 0 ) , ( 4 , 0 ) , ( 5 , 0 ) , ( 6 , 0 ) , … , ( {N}_{symb} - 1 , 0 ) \} .$$

For a tenth example (e.g., 1602 in FIG. 16) of this sub-embodiment,

$${N}_{1} = 3 , {S}_{1} = \{ ( 0 , {L}_{2} ) , ( 1 , {L}_{2} / 2 ) , ( 2 , 0 ) \} , {N}_{2} = 2 , {S}_{2} = \{ ( 0 , 0 ) , ( 2 , {L}_{2} ) , \} , {N}_{3} = 13 , {S}_{3} = \{ ( 1 , 0 ) , ( 1 , \frac{{L}_{2}}{2} + {L}_{1} ) , ( 3 , 0 ) , ( 4 , 0 ) , ( 5 , 0 ) , ( 6 , 0 ) , … , ( {N}_{symb} - 1 , 0 ) \} .$$

For a eleventh example (e.g., 1603 in FIG. 16) of this sub-embodiment,

$${N}_{1} = 3 , {S}_{1} = \{ ( 0 , {L}_{2} ) , ( 2 , {L}_{2} / 4 ) , ( 3 , 0 ) \} , {N}_{2} = 2 , {S}_{2} = \{ ( 0 , 0 ) , ( 1 , {L}_{2} / 2 ) \} , {N}_{3} = 15 , {S}_{3} = \{ ( 1 , 0 ) , ( 1 , 3 {L}_{2} / 2 ) ( 2 , 0 ) , ( 2 , \frac{{L}_{2}}{4} + {L}_{1} ) , ( 3 , {L}_{1} ) , ( 4 , 0 ) , ( 5 , 0 ) , ( 6 , 0 ) , … , ( {N}_{symb} - 1 , 0 ) \} .$$

For a twelfth example (e.g., 1604 in FIG. 16) of this sub-embodiment, N₁=2, S₁={(0, 0), (0, L₁)}, N₂=2, S₂={(1, 0), (1, L₁)}, N₃=12, S₃={(2, 0), (3, 0), (4, 0), (5, 0), (6, 0), (N_{symb}−1, 0)}.

For a thirteenth example (e.g., 1605 in FIG. 16) of this sub-embodiment, N₁=3, S₁={(1, 0), (2, 0), (2, L₁)}, N₂=3, S₂={(0, 0), (0, L₂), (1, L₂)}, N₃=11, 53={(3, 0), (4, 0), (5, 0), (6, 0), . . . (N_{symb}−1, 0)}.

For a fourteenth example (e.g., 1606 in FIG. 16) of this sub-embodiment, N₁=3, S₁={(0, 0), (0, L₁), (1, L₁)}, N₂=3, 52={(1, 0), (2, 0), (2, L₂)}, N₃=11, S₃={(3, 0), (4, 0), (5, 0), (6, 0), . . . (N_{symb}−1, 0).

For a fifteenth example (e.g., 1701 in FIG. 17) of this sub-embodiment, N₁=2, S₁={(1, 0), (2, L₁)}, N₂=2, S₂={(5, 0), (8, 0)}, N₃=14, S₃={(0, 0), (1, L₁), (2, 0), (3, 0), (4, 0), (5, L₁), (6, 0), . . . , (N_{symb}−1, 0)}.

For a sixteenth example (e.g., 1702 in FIG. 17) of this sub-embodiment, N₁=2, S₁={(1, 0), (2, L₁)}, N₂=2, S₂={(1, L₁), (2, 0)}, N₃=12, S₃={(0, 0), (3, 0), (4, 0), (5, 0), (6, 0), . . . , (N_{symb}−1, 0)}.

For a seventeenth example (e.g., 1703 in FIG. 17) of this sub-embodiment, N₁=2, S₁={(1, 0), (2, 0)}, N₂=2, 52={(1, L₁), (2, L₁)}, N₃=12, S₃={(0, 0), (3, 0), (4, 0), (5, 0), (6, 0), . . . (N_{symb}−1,0)}.

For a eighteenth example (e.g., 1704 in FIG. 17) of this sub-embodiment, N₁=2, S₁={(1, 0), (3, 0)}, N₂=2, 52={(2, L₁), (4, L₁)}, N₃=14, 53={(0, 0), (1, L₁), (2, 0), (3, L₁), (4, 0), (5, 0), (6, 0), . . . , (N_{symb}−1, 0)}.

For a nineteenth example (e.g., 1705 in FIG. 17) of this sub-embodiment, N₁=2, S₁={(2, L₁/2), (3, L₁/2)}, N₂=2, S₂={(1, 0), (1, L₁)}, N₃=15, S₃={(0, 0), (2, 0), (2, 3L₁/2), (3, 0), (3, 3L₁/2), (4, 0), (5, 0), (6, 0), . . . , (N_{symb}−1, 0)}.

For a twentieth example (e.g., 1706 in FIG. 17) of this sub-embodiment,

$${N}_{1} = 3 , {S}_{1} = \{ ( 1 , 0 ) , ( 1 , {L}_{1} ) , ( 3 , {L}_{1} / 2 ) \} , {N}_{2} = 2 , {S}_{2} = \{ ( 2 , {L}_{1} / 2 ) , ( 4 , {L}_{1} / 2 ) \} , {N}_{3} = 16 , {S}_{3} = \{ ( 0 , 0 ) , ( 2 , 0 ) , ( 2 , \frac{{L}_{1}}{2} + {L}_{2} ) , ( 3 , 0 ) , ( 3 , \frac{3 {L}_{1}}{2} ) , ( 4 , 0 ) , ( 4 , \frac{{L}_{1}}{2} + {L}_{2} ) , ( 5 , 0 ) , ( 6 , 0 ) , … , ( {N}_{symb} - 1 , 0 ) \} .$$

For a twenty-first example (e.g., 1707 in FIG. 17) of this sub-embodiment,

$${N}_{1} = 2 , {S}_{1} = \{ ( 1 , 0 ) , ( 3 , {L}_{1} / 2 ) \} , {N}_{2} = 2 , {S}_{2} = \{ ( 2 , {L}_{1} / 2 ) , ( 4 , {L}_{1} ) \} , {N}_{3} = 16 , {S}_{3} = \{ ( 0 , 0 ) , ( 1 , {L}_{1} ) , ( 2 , 0 ) , ( 2 , \frac{{L}_{1}}{2} + {L}_{2} ) , ( 3 , 0 ) , ( 3 , \frac{3 {L}_{1}}{2} ) , ( 4 , 0 ) , ( 5 , 0 ) , ( 6 , 0 ) , … , ( {N}_{symb} - 1 , 0 ) \} .$$

For a twenty-second example (e.g., 1708 in FIG. 17) of this sub-embodiment,

$${N}_{1} = 2 , {S}_{1} = \{ ( 1 , {L}_{1} / 2 ) , ( 3 , {L}_{1} / 2 ) \} , {N}_{2} = 2 , {S}_{2} = \{ ( 2 , 0 ) , ( 2 , {L}_{2} / 2 ) \} , {N}_{3} = 15 , {S}_{3} = \{ ( 0 , 0 ) , ( 1 , 0 ) , ( 1 , \frac{3 {L}_{1}}{2} ) , ( 3 , 0 ) , ( 3 , \frac{3 {L}_{1}}{2} ) , ( 4 , 0 ) , ( 5 , 0 ) , ( 6 , 0 ) , … , ( {N}_{symb} - 1 , 0 ) \} .$$

For a twenty-third example (e.g., 1801 in FIG. 18) of this sub-embodiment,

$${N}_{1} = 2 , {S}_{1} = \{ ( 2 , {L}_{2} / 2 ) , ( 3 , {L}_{2} / 2 ) \} , {N}_{2} = 2 , {S}_{2} = \{ ( 1 , 0 ) , ( 1 , {L}_{2} ) \} , {N}_{3} = 15 , {S}_{3} = \{ ( 0 , 0 ) , ( 2 , 0 ) , ( 2 , \frac{{L}_{2}}{2} + {L}_{1} ) , ( 3 , 0 ) , ( 3 , \frac{{L}_{2}}{2} + {L}_{1} ) , ( 4 , 0 ) , ( 5 , 0 ) , ( 6 , 0 ) , … , ( {N}_{symb} - 1 , 0 ) \} .$$

For a twenty-fourth example (e.g., 1802 in FIG. 18) of this sub-embodiment,

$${N}_{1} = 3 , {S}_{1} = \{ ( 1 , {L}_{2} ) , ( 2 , {L}_{2} / 2 ) , ( 3 , 0 ) \} , {N}_{2} = 2 , {S}_{2} = \{ ( 1 , 0 ) , ( 3 , {L}_{2} ) , \} , {N}_{3} = 13 , {S}_{3} = \{ ( 0 , 0 ) , ( 2 , 0 ) , ( 2 , \frac{{L}_{2}}{2} + {L}_{1} ) , ( 4 , 0 ) , ( 5 , 0 ) , ( 6 , 0 ) , … , ( {N}_{symb} - 1 , 0 ) \} .$$

For a twenty-fifth example (e.g., 1803 in FIG. 18) of this sub-embodiment,

$${N}_{1} = 3 , {S}_{1} = \{ ( 1 , {L}_{2} ) , ( 3 , {L}_{2} / 4 ) , ( 4 , 0 ) \} , {N}_{2} = 2 , {S}_{2} = \{ ( 1 , 0 ) , ( 2 , {L}_{2} / 2 ) \} , {N}_{3} = 15 , {S}_{3} = \{ ( 0 , 0 ) , ( 2 , 0 ) , ( 2 , 3 {L}_{2} / 2 ) , ( 3 , 0 ) , ( 3 , \frac{{L}_{2}}{4} + {L}_{1} ) , ( 4 , {L}_{1} ) , ( 5 , 0 ) , ( 6 , 0 ) , … , ( {N}_{symb} - 1 , 0 ) \} .$$

For a twenty-sixth example (e.g., 1804 in FIG. 18) of this sub-embodiment, N₁=2, S₁={(1, 0), (1, L₁)}, N₂=2, S₂={(2, 0), (2, L₁)}, N₃=12, S₃={(0, 0), (3, 0), (4, 0), (5, 0), (6, 0), . . . , (N_{symb}−1, 0)}.

For a twenty-seventh example (e.g., 1805 in FIG. 18) of this sub-embodiment, N₁=3, S₁={(2, 0), (3, 0), (3, L₁)}, N₂=3, S₂={(1, 0), (1, L₂), (2, L₂)}, N₃=11, S₃={(0, 0), (4, 0), (5, 0), (6, 0), . . . , (N_{symb}−1, 0)}.

For a twenty-eighth example (e.g., 1806 in FIG. 18) of this sub-embodiment, N₁=3, S₁={(1, 0), (1, L₁), (2, L₁)}, N₂=3, 52={(2, 0), (3, 0), (3, L₂)}, N₃=11, S₃={(0, 0), (4, 0), (5, 0), (6, 0), . . . , (N_{symb}−1, 0)}.

In one further evaluation for the examples of this sub-embodiment, the SSB with 14 OFDM symbols can be mapped from a first OFDM symbol in a slot, e.g., #0 of the SSB is aligned with #0 of a slot.

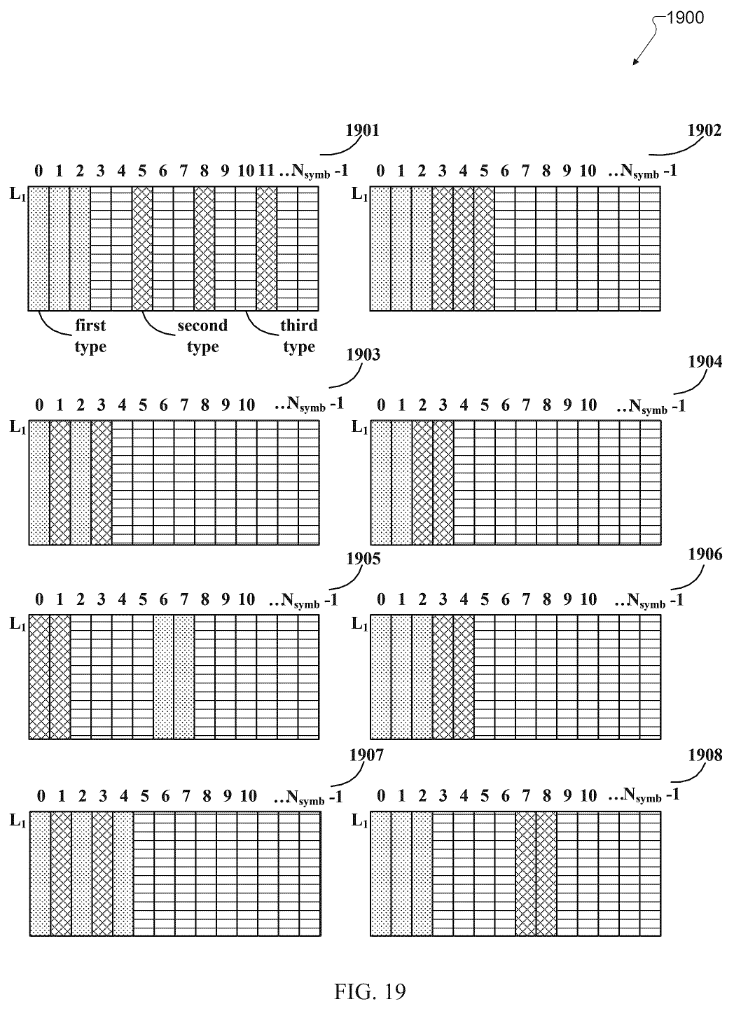

FIG. 19 illustrates diagrams of example SSB architectures 1900 according to embodiments of the present disclosure. For example, SSB architectures 1900 can be utilized by any of the UEs 111-116 of FIG. 1, such as the UE 114. This example is for illustration only and other embodiments can be used without departing from the scope of the present disclosure.

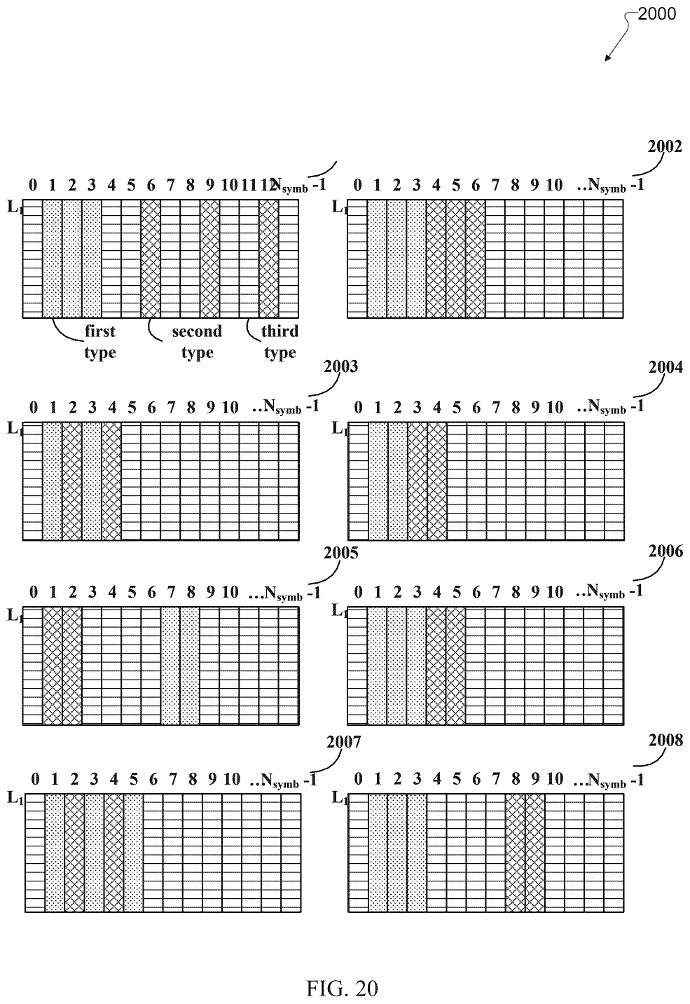

FIG. 20 illustrates diagrams of example SSB architectures 2000 according to embodiments of the present disclosure. For example, SSB architectures 2000 can be utilized by any of the UEs 111-116 of FIG. 1, such as the UE 115. This example is for illustration only and other embodiments can be used without departing from the scope of the present disclosure.

In one sub-embodiment, N_{RB}=L₁. For one example, L₁=24 and/or L₂=24.

For a first example (e.g., 1901 in FIG. 19) of this sub-embodiment, N₁=3, S₁={(0, 0), (1, 0), (2, 0)}, N₂=3, S₂={(5, 0), (8, 0), (11, 0)}, N₃=8, S₃={(3, 0), (4, 0), (6, 0), . . . , (N_{symb}−1, 0)}.

For a second example (e.g., 1902 in FIG. 19) of this sub-embodiment, N₁=3, S₁={(0, 0), (1, 0), (2, 0)}, N₂=3, S₂={(3, 0), (4, 0), (5, 0)}, N₃=8, 53={(6, 0), . . . , (N_{symb}−1, 0)}.

For a third example (e.g., 1903 in FIG. 19) of this sub-embodiment, N₁=2, S₁={(0, 0), (2, 0)}, N₂=2, S₂={(1, 0), (3, 0)}, N₃=10, S₃={(4, 0), (5, 0), (6, 0), . . . , (N_{symb}−1, 0)}.

For a fourth example (e.g., 1904 in FIG. 19) of this sub-embodiment, N₁=2, S₁={(0, 0), (1, 0)}, N₂=2, S₂={(2, 0), (3, 0)}, N₃=10, S₃={(4, 0), (5, 0), (6, 0), . . . , (N_{symb}−1, 0)}.

For a fifth example (e.g., 1905 in FIG. 19) of this sub-embodiment, N₁=2, S₁={(6, 0), (7, 0)}, N₂=2, S₂={(0, 0), (1, 0)}, N₃=10, S₃={(2, 0), (3, 0), (4, 0), (5, 0), (8, 0), . . . , (N_{symb}−1, 0)}.

For a sixth example (e.g., 1906 in FIG. 19) of this sub-embodiment, N₁=3, S₁={(0, 0), (1, 0), (2, 0)}, N₂=2, S₂={(3, 0), (4, 0)}, N₃=9, S₃={(5, 0), (6, 0), . . . , (N_{symb}−1, 0)}.

For a seventh example (e.g., 1907 in FIG. 19) of this sub-embodiment, N₁=3, S₁={(0, 0), (2, 0), (4, 0)}, N₂=2, S₂={(1, 0), (3, 0)}, N₃=9, S₃={(5, 0), (6, 0), . . . , (N_{symb}−1, 0)}.

For a eighth example (e.g., 1908 in FIG. 19) of this sub-embodiment, N₁=3, 51={(0, 0), (1, 0), (2, 0)}, N₂=2, S₂={(7, 0), (8, 0)}, N₃=9, S₃={(3, 0), (4, 0), (5, 0), (6, 0), (N_{symb}−1, 0)}.

For a ninth example (e.g., 2001 in FIG. 20) of this sub-embodiment, N₁=3, S₁={(1, 0), (2, 0), (3, 0)}, N₂=3, S₂={(6, 0), (9, 0), (12, 0)}, N₃=8, S₃={(0, 0), (4, 0), (5, 0), (7, 0), . . . , (N_{symb}−1, 0)}.

For a tenth example (e.g., 2002 in FIG. 20) of this sub-embodiment, N₁=3, S₁={(1, 0), (2, 0), (3, 0)}, N₂=3, S₂=(4, 0), (5, 0), (6, 0)}, N₃=8, S₃={(0, 0), (7, 0), . . . , (N_{symb}−1, 0)}.

For a eleventh example (e.g., 2003 in FIG. 20) of this sub-embodiment, N₁=2, S₁={(1, 0), (3, 0)}, N₂=2, S₂={(2, 0), (4, 0)}, N₃=10, S₃={(0, 0), (5, 0), (6, 0), . . . , (N_{symb}−1, 0)}.

For a twelfth example (e.g., 2004 in FIG. 20) of this sub-embodiment, N₁=2, S₁={(1, 0), (2, 0)}, N₂=2, S₂={(3, 0), (4, 0)}, N₃=10, S₃={(0, 0), (5, 0), (6, 0), . . . , (N_{symb}−1, 0)}.

For a thirteenth example (e.g., 2005 in FIG. 20) of this sub-embodiment, N₁=2, S₁={(7, 0), (8, 0)}, N₂=2, S₂={(1, 0), (2, 0)}, N₃=10, S₃={(0, 0), (3, 0), (4, 0), (5, 0), (6, 0), (9, 0), . . . , (N_{symb}−1, 0)}.

For a fourteenth example (e.g., 2006 in FIG. 20) of this sub-embodiment, N₁=3, S₁={(1, 0), (2, 0), (3, 0)}, N₂=2, S₂={(4, 0), (5, 0)}, N₃=9, S₃={(0, 0), (6, 0), . . . , (N_{symb}−1, 0)}.

For a fifteenth example (e.g., 2007 in FIG. 20) of this sub-embodiment, N₁=3, S₁={(1, 0), (3, 0), (5, 0)}, N₂=2, S₂={(2, 0), (4, 0)}, N₃=9, S₃={(0, 0), (6, 0), (N_{symb}−1, 0)}.

For a sixteenth example (e.g., 2008 in FIG. 20) of this sub-embodiment, N₁=3, S₁={(1, 0), (2, 0), (3, 0)}, N₂=2, S₂={(8, 0), (9, 0)}, N₃=9, S₃={(0, 0), (4, 0), (5, 0), (6, 0), . . . , (N_{symb}−1,0)}.

In one further evaluation for the examples of this sub-embodiment, the SSB with 14 OFDM symbols can be mapped from a first OFDM symbol in a slot, e.g., #0 of the SSB is aligned with #0 of a slot.

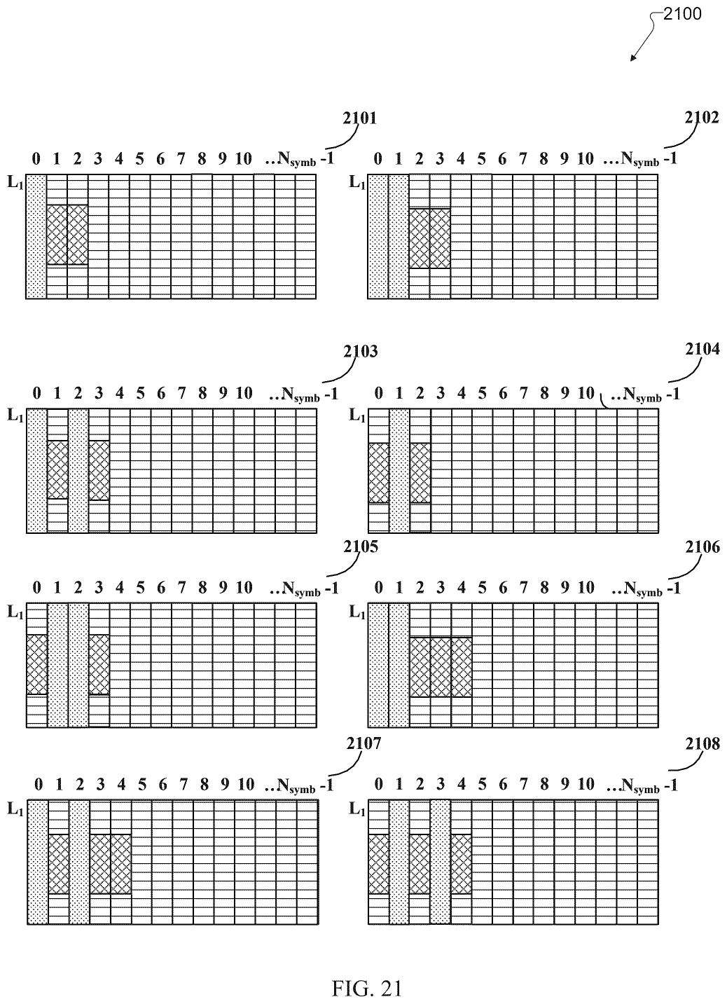

FIG. 21 illustrates diagrams of example SSB architectures 2100 according to embodiments of the present disclosure. For example, SSB architectures 2100 can be utilized by any of the UEs 111-116 of FIG. 1, such as the UE 116. This example is for illustration only and other embodiments can be used without departing from the scope of the present disclosure.

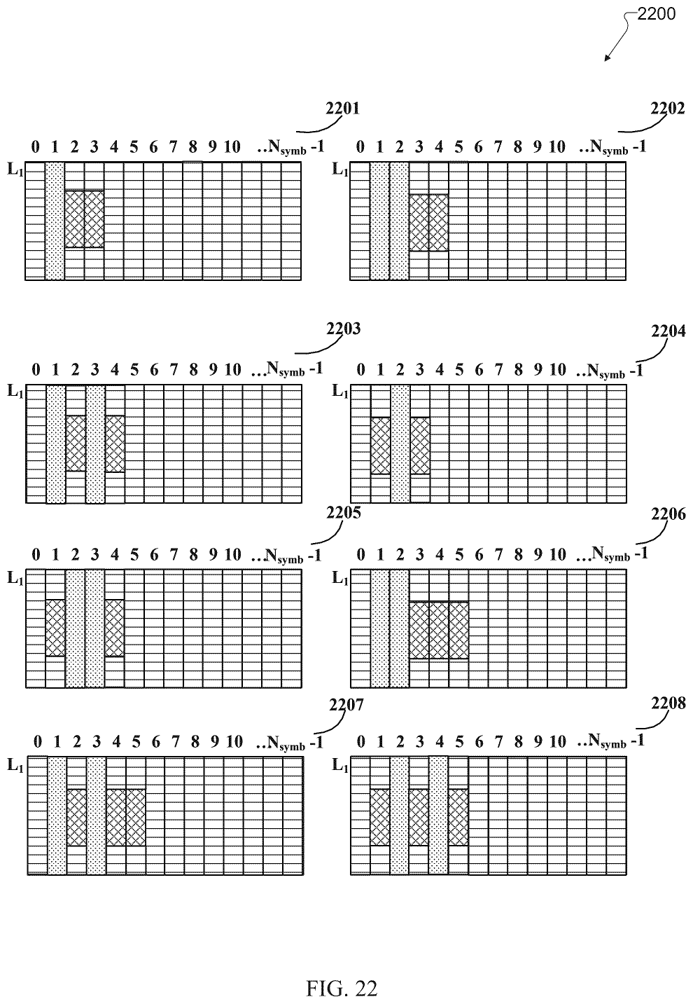

FIG. 22 illustrates diagrams of example SSB architectures 2200 according to embodiments of the present disclosure. For example, SSB architectures 2200 can be utilized by the UE 116 of FIG. 3. This example is for illustration only and other embodiments can be used without departing from the scope of the present disclosure.

In one sub-embodiment, N_{RB}=L₁. For one example, L₁=24 and/or L₂=12 or 11. For a first example (e.g., 2101 in FIG. 21) of this sub-embodiment,

$${N}_{1} = 1 , {S}_{1} = \{ ( 0 , 0 ) \} , {N}_{2} = 2 , {S}_{2} = \{ ( 1 , \frac{{L}_{1}}{4} ) , ( 2 , \frac{{L}_{1}}{4} ) \} , {N}_{3} = 15 , {S}_{3} = \{ ( 1 , 0 ) , ( 1 , \frac{{L}_{1}}{4} + {L}_{2} ) , ( 2 , 0 ) , ( 2 , \frac{{L}_{1}}{4} + {L}_{2} ) , ( 3 , 0 ) , ( 4 , 0 ) , ( 5 , 0 ) , ( 6 , 0 ) , … , ( {N}_{symb} - 1 , 0 ) \} .$$

For a second example (e.g., 2102 in FIG. 21) of this sub-embodiment,

$${N}_{1} = 2 , {S}_{1} = \{ ( 0 , 0 ) , ( 1 , 0 ) \} , {N}_{2} = 2 , {S}_{2} = \{ ( 2 , \frac{{L}_{1}}{4} ) , ( 3 , \frac{{L}_{1}}{4} ) \} , {N}_{3} = 14 , {S}_{3} = \{ ( 2 , 0 ) , ( 2 , \frac{{L}_{1}}{4} + {L}_{2} ) , ( 3 , 0 ) , ( 3 , \frac{{L}_{1}}{4} + {L}_{2} ) , ( 4 , 0 ) , ( 5 , 0 ) , ( 6 , 0 ) , … , ( {N}_{symb} - 1 , 0 ) \} .$$

For a third example (e.g., 2103 in FIG. 21) of this sub-embodiment,

$${N}_{1} = 2 , {S}_{1} = \{ ( 0 , 0 ) , ( 2 , 0 ) \} , {N}_{2} = 2 , {S}_{2} = \{ ( 1 , \frac{{L}_{1}}{4} ) , ( 3 , \frac{{L}_{1}}{4} ) \} , {N}_{3} = 14 , {S}_{3} = \{ ( 1 , 0 ) , ( 1 , \frac{{L}_{1}}{4} + {L}_{2} ) , ( 3 , 0 ) , ( 3 , \frac{{L}_{1}}{4} \\ + {L}_{2} ) , ( 4 , 0 ) , ( 5 , 0 ) , ( 6 , 0 ) , …… , ( {N}_{symb} - 1 , 0 ) \} .$$

For a fourth example (e.g., 2104 in FIG. 21) of this sub-embodiment,

$${N}_{1} = 1 , {S}_{1} = \{ ( 1 , 0 ) \} , {N}_{2} = 2 , {S}_{2} = \{ ( 0 , \frac{{L}_{1}}{4} ) , ( 2 , \frac{{L}_{1}}{4} ) \} , {N}_{3} = 15 , {S}_{3} = \{ ( 0 , 0 ) , ( 0 , \frac{{L}_{1}}{4} + {L}_{2} ) , ( 2 , 0 ) , ( 2 , \frac{{L}_{1}}{4} \\ + {L}_{2} ) , ( 3 , 0 ) , ( 4 , 0 ) , ( 6 , 0 ) , …… , ( {N}_{symb} - 1 , 0 ) \} .$$

For a fifth example (e.g., 2105 in FIG. 21) of this sub-embodiment,

$${N}_{1} = 2 , {S}_{1} = \{ ( 1 , 0 ) , ( 2 , 0 ) \} , {N}_{2} = 2 , {S}_{2} = \{ ( 0 , \frac{{L}_{1}}{4} ) , ( 3 , \frac{{L}_{1}}{4} ) \} , {N}_{3} = 14 , {S}_{3} = \{ ( 0 , 0 ) , ( 0 , \frac{{L}_{1}}{4} + {L}_{2} ) , ( 3 , 0 ) , ( 3 , \frac{{L}_{1}}{4} \\ + {L}_{2} ) , ( 4 , 0 ) , ( 5 , 0 ) , ( 6 , 0 ) , …… , ( {N}_{symb} - 1 , 0 ) \} .$$

For a sixth example (e.g., 2106 in FIG. 21) of this sub-embodiment,

$${N}_{1} = 2 , {S}_{1} = \{ ( 0 , 0 ) , ( 1 , 0 ) \} , {N}_{2} = 3 , {S}_{2} = \{ ( 2 , \frac{{L}_{1}}{4} ) , ( 3 , \frac{{L}_{1}}{4} ) , ( 4 , \frac{{L}_{1}}{4} ) \} , {N}_{3} = 15 , {S}_{3} = \{ ( 2 , 0 ) , ( 2 , \frac{{L}_{1}}{4} + {L}_{2} ) , ( 3 , 0 ) , ( 3 , \frac{{L}_{1}}{4} \\ + {L}_{2} ) , ( 4 , 0 ) , ( 4 , \frac{{L}_{1}}{4} + {L}_{2} ) , ( 5 , 0 ) , ( 6 , 0 ) , …… , ( {N}_{symb} - 1 , 0 ) \} .$$

For a seventh example (e.g., 2107 in FIG. 21) of this sub-embodiment,

$${N}_{1} = 2 , {S}_{1} = \{ ( 0 , 0 ) , ( 2 , 0 ) \} , {N}_{2} = 3 , {S}_{2} = \{ ( 1 , \frac{{L}_{1}}{4} ) , ( 3 , \frac{{L}_{1}}{4} ) , ( 4 , \frac{{L}_{1}}{4} ) \} , {N}_{3} = 15 , {S}_{3} = \{ ( 1 , 0 ) , ( 1 , \frac{{L}_{1}}{4} + {L}_{2} ) , ( 3 , 0 ) , ( 3 , \frac{{L}_{1}}{4} \\ + {L}_{2} ) , ( 4 , 0 ) , ( 4 , \frac{{L}_{1}}{4} + {L}_{2} ) , ( 5 , 0 ) , ( 6 , 0 ) , …… , ( {N}_{symb} - 1 , 0 ) \} .$$

For a eighth example (e.g., 2108 in FIG. 21) of this sub-embodiment,

$${N}_{1} = 2 , {S}_{1} = \{ ( 1 , 0 ) , ( 3 , 0 ) \} , {N}_{2} = 3 , {S}_{2} = \{ ( 0 , \frac{{L}_{1}}{4} ) , ( 2 , \frac{{L}_{1}}{4} ) , ( 4 , \frac{{L}_{1}}{4} ) \} , {N}_{3} = 15 , {S}_{3} = \{ ( 0 , 0 ) , ( 0 , \frac{{L}_{1}}{4} + {L}_{2} ) , ( 2 , 0 ) , ( 2 , \frac{{L}_{1}}{4} \\ + {L}_{2} ) , ( 4 , 0 ) , ( 4 , \frac{{L}_{1}}{4} + {L}_{2} ) , ( 5 , 0 ) , ( 6 , 0 ) , …… , ( {N}_{symb} - 1 , 0 ) \} .$$

For a ninth example (e.g., 2201 in FIG. 22) of this sub-embodiment,

$${N}_{1} = 1 , {S}_{1} = \{ ( 1 , 0 ) \} , {N}_{2} = 2 , {S}_{2} = \{ ( 2 , \frac{{L}_{1}}{4} ) , ( 3 , \frac{{L}_{1}}{4} ) \} , {N}_{3} = 15 , {S}_{3} = \{ ( 0 , 0 ) , ( 2 , 0 ) , ( 2 , \frac{{L}_{1}}{4} + {L}_{2} ) , ( 3 , 0 ) , ( 3 , \frac{{L}_{1}}{4} \\ + {L}_{2} ) , ( 4 , 0 ) , ( 5 , 0 ) , ( 6 , 0 ) , …… , ( {N}_{symb} - 1 , 0 ) \} .$$

For a tenth example (e.g., 2202 in FIG. 22) of this sub-embodiment,

$${N}_{1} = 2 , {S}_{1} = \{ ( 1 , 0 ) , ( 2 , 0 ) \} , {N}_{2} = 2 , {S}_{2} = \{ ( 3 , \frac{{L}_{1}}{4} ) , ( 4 , \frac{{L}_{1}}{4} ) \} , {N}_{3} = 14 , {S}_{3} = \{ ( 0 , 0 ) , ( 3 , 0 ) , ( 3 , \frac{{L}_{1}}{4} + {L}_{2} ) , ( 4 , 0 ) , ( 4 , \frac{{L}_{1}}{4} \\ + {L}_{2} ) , ( 5 , 0 ) , ( 6 , 0 ) , …… , ( {N}_{symb} - 1 , 0 ) \} .$$

For a eleventh example (e.g., 2203 in FIG. 22) of this sub-embodiment,

$${N}_{1} = 2 , {S}_{1} = \{ ( 1 , 0 ) , ( 3 , 0 ) \} , {N}_{2} = 2 , {S}_{2} = \{ ( 2 , \frac{{L}_{1}}{4} ) , ( 4 , \frac{{L}_{1}}{4} ) \} , {N}_{3} = 14 , {S}_{3} = \{ ( 0 , 0 ) , ( 2 , 0 ) , ( 2 , \frac{{L}_{1}}{4} + {L}_{2} ) , ( 4 , 0 ) , ( 4 , \frac{{L}_{1}}{4} \\ + {L}_{2} ) , ( 5 , 0 ) , ( 6 , 0 ) , …… , ( {N}_{symb} - 1 , 0 ) \} .$$

For a twelfth example (e.g., 2204 in FIG. 22) of this sub-embodiment,

$${N}_{1} = 1 , {S}_{1} = \{ ( 2 , 0 ) \} , {N}_{2} = 2 , {S}_{2} = \{ ( 1 , \frac{{L}_{1}}{4} ) , ( 3 , \frac{{L}_{1}}{4} ) \} , {N}_{3} = 15 , {S}_{3} = \{ ( 0 , 0 ) , ( 1 , 0 ) , ( 1 , \frac{{L}_{1}}{4} + {L}_{2} ) , ( 3 , 0 ) , ( 3 , \frac{{L}_{1}}{4} \\ + {L}_{2} ) , ( 4 , 0 ) , ( 5 , 0 ) , ( 6 , 0 ) , …… , ( {N}_{symb} - 1 , 0 ) \} .$$

For a thirteenth example (e.g., 2205 in FIG. 22) of this sub-embodiment,

$${N}_{1} = 2 , {S}_{1} = \{ ( 2 , 0 ) , ( 3 , 0 ) \} , {N}_{2} = 2 , {S}_{2} = \{ ( 1 , \frac{{L}_{1}}{4} ) , ( 4 , \frac{{L}_{1}}{4} ) \} , {N}_{3} = 14 , {S}_{3} = \{ ( 0 , 0 ) , ( 1 , 0 ) , ( 1 , \frac{{L}_{1}}{4} + {L}_{2} ) , ( 4 , 0 ) , ( 4 , \frac{{L}_{1}}{4} \\ + {L}_{2} ) , ( 5 , 0 ) , ( 6 , 0 ) , …… , ( {N}_{symb} - 1 , 0 ) \} .$$

For a fourteenth example (e.g., 2206 in FIG. 22) of this embodiment,

$${N}_{1} = 2 , {S}_{1} = \{ ( 1 , 0 ) , ( 2 , 0 ) \} , {N}_{2} = 3 , {S}_{2} = \{ ( 3 , \frac{{L}_{1}}{4} ) , ( 4 , \frac{{L}_{1}}{4} ) , ( 5 , \frac{{L}_{1}}{4} ) \} , {N}_{3} = 15 , {S}_{3} = \{ ( 0 , 0 ) , ( 3 , 0 ) , ( 3 , \frac{{L}_{1}}{4} + {L}_{2} ) , ( 4 , 0 ) , ( 4 , \frac{{L}_{1}}{4} \\ + {L}_{2} ) , ( 5 , 0 ) , ( 5 , \frac{{L}_{1}}{4} + {L}_{2} ) , ( 6 , 0 ) , …… , ( {N}_{symb} - 1 , 0 ) \} .$$

For a fifteenth example (e.g., 2207 in FIG. 22) of this sub-embodiment,

$${N}_{1} = 2 , {S}_{1} = \{ ( 1 , 0 ) , ( 3 , 0 ) \} , {N}_{2} = 3 , {S}_{2} = \{ ( 2 , \frac{{L}_{1}}{4} ) , ( 4 , \frac{{L}_{1}}{4} ) , ( 5 , \frac{{L}_{1}}{4} ) \} , {N}_{3} = 15 , {S}_{3} = \{ ( 0 , 0 ) , ( 2 , 0 ) , ( 2 , \frac{{L}_{1}}{4} + {L}_{2} ) , ( 4 , 0 ) , ( 4 , \frac{{L}_{1}}{4} \\ + {L}_{2} ) , ( 5 , 0 ) , ( 5 , \frac{{L}_{1}}{4} + {L}_{2} ) , ( 6 , 0 ) , …… , ( {N}_{symb} - 1 , 0 ) \} .$$

For a sixteenth example (e.g., 2208 in FIG. 22) of this sub-embodiment,

$${N}_{1} = 2 , {S}_{1} = \{ ( 2 , 0 ) , ( 4 , 0 ) \} , {N}_{2} = 3 , {S}_{2} = \{ ( 1 , \frac{{L}_{1}}{4} ) , ( 3 , \frac{{L}_{1}}{4} ) , ( 5 , \frac{{L}_{1}}{4} ) \} , {N}_{3} = 15 , {S}_{3} = \{ ( 0 , 0 ) , ( 1 , 0 ) , ( 1 , \frac{{L}_{1}}{4} + {L}_{2} ) , ( 3 , 0 ) , ( 3 , \frac{{L}_{1}}{4} \\ + {L}_{2} ) , ( 5 , 0 ) , ( 5 , \frac{{L}_{1}}{4} + {L}_{2} ) , ( 6 , 0 ) , …… , ( {N}_{symb} - 1 , 0 ) \} .$$

In one further evaluation for the examples of this sub-embodiment, the SSB with 14 OFDM symbols can be mapped from a first OFDM symbol in a slot, e.g., #0 of the SSB is aligned with #0 of a slot.

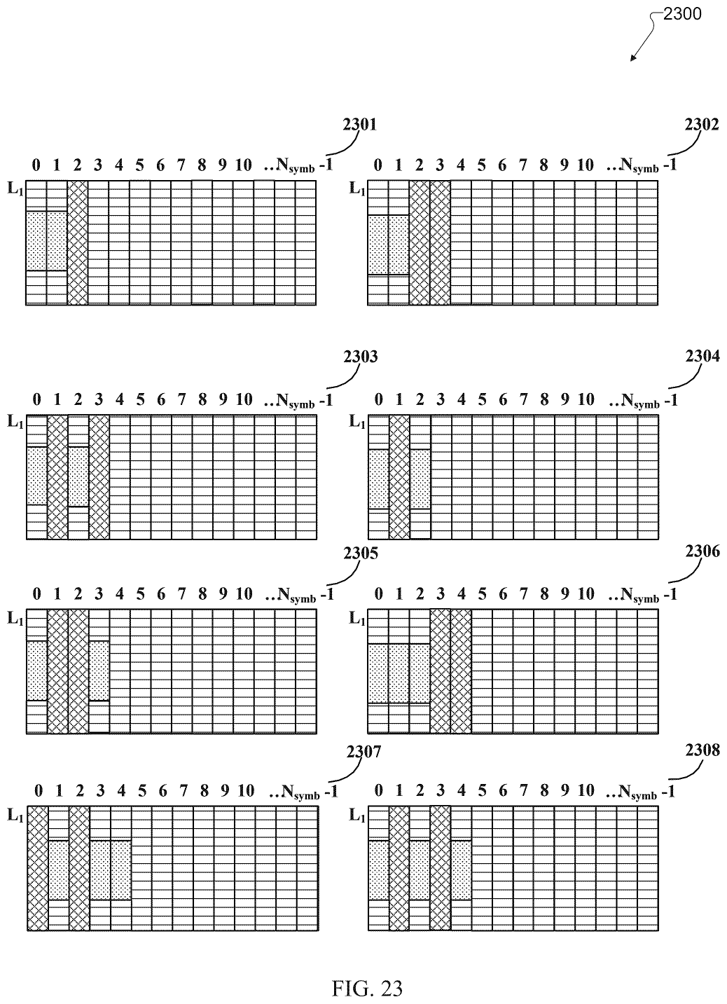

FIG. 23 illustrates diagrams of example SSB architectures 2300 according to embodiments of the present disclosure. For example, SSB architectures 2300 can be utilized by any of the UEs 111-116 of FIG. 1. This example is for illustration only and other embodiments can be used without departing from the scope of the present disclosure.

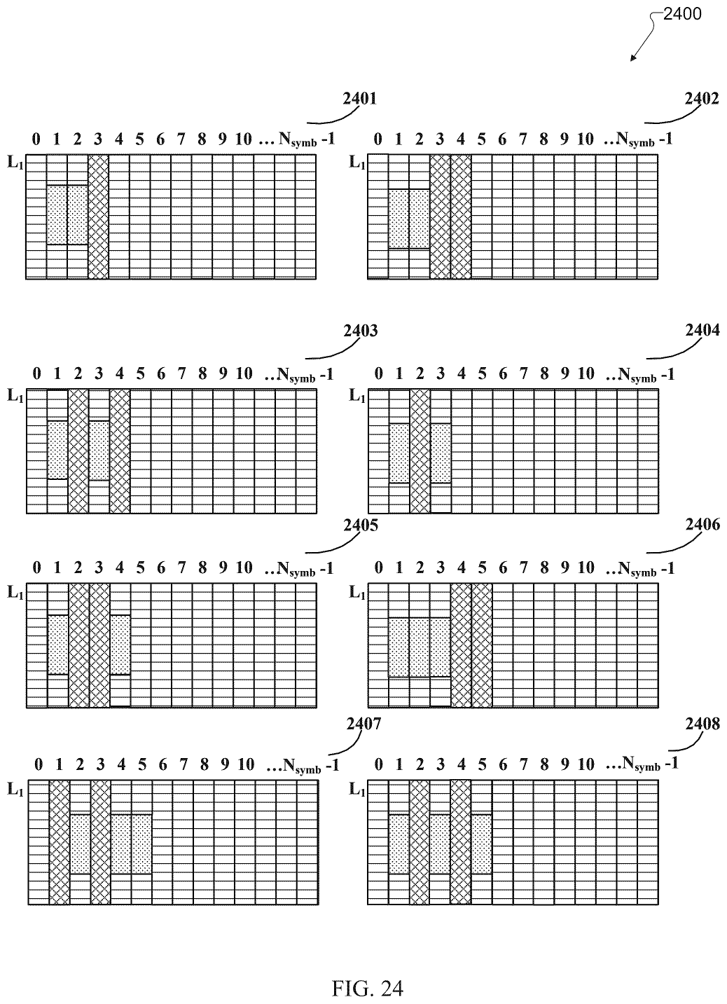

FIG. 24 illustrates diagrams of example SSB architectures 2400 according to embodiments of the present disclosure. For example, SSB architectures 2400 can be utilized by any of the UEs 111-116 of FIG. 1, such as the UE 111. This example is for illustration only and other embodiments can be used without departing from the scope of the present disclosure.

In one sub-embodiment, N_{RB}=L₂. For one example, L₁=12 or 11 and/or L₂=24. For a first example (e.g., 2301 in FIG. 23) of this sub-embodiment,

$${N}_{1} = 2 , {S}_{1} = \{ ( 0 , \frac{{L}_{1}}{4} ) , ( 1 , \frac{{L}_{1}}{4} ) \} , {N}_{2} = 1 , {S}_{2} = \{ ( 2 , 0 ) \} , {N}_{3} = 15 , {S}_{3} = \{ ( 0 , 0 ) , ( 0 , \frac{{L}_{1}}{4} + {L}_{2} ) , ( 1 , 0 ) , ( 1 , \frac{{L}_{1}}{4} + {L}_{2} ) , ( 3 , 0 ) , ( 4 , 0 ) , ( 5 , 0 ) , ( 6 , 0 ) , …… , ( {N}_{symb} - 1 , 0 ) \} .$$

For a second example (e.g., 2302 in FIG. 23) of this sub-embodiment,

$${N}_{1} = 2 , {S}_{1} = \{ ( 0 , \frac{{L}_{1}}{4} ) , ( 1 , \frac{{L}_{1}}{4} ) \} , {N}_{2} = 2 , {S}_{2} = \{ ( 2 , 0 ) , ( 3 , 0 ) \} , {N}_{3} = 14 , {S}_{3} = \{ ( 0 , 0 ) , ( 0 , \frac{{L}_{1}}{4} + {L}_{2} ) , ( 1 , 0 ) , ( 1 , \frac{{L}_{1}}{4} + {L}_{2} ) , ( 4 , 0 ) , ( 5 , 0 ) , ( 6 , 0 ) , … … , ( {N}_{symb} - 1 , 0 ) \} .$$

For a third example (e.g., 2303 in FIG. 23) of this sub-embodiment,

$${N}_{1} = 2 , {S}_{1} = \{ ( 0 , \frac{{L}_{1}}{4} ) , ( 2 , \frac{{L}_{1}}{4} ) \} , {N}_{2} = 2 , {S}_{2} = \{ ( 1 , 0 ) , ( 3 , 0 ) \} , {N}_{3} = 14 , {S}_{3} = \{ ( 0 , 0 ) , ( 0 , \frac{{L}_{1}}{4} + {L}_{2} ) , ( 2 , 0 ) , ( 2 , \frac{{L}_{1}}{4} + {L}_{2} ) , ( 4 , 0 ) , ( 5 , 0 ) , ( 6 , 0 ) , … … , ( {N}_{symb} - 1 , 0 ) \} .$$

For a fourth example (e.g., 2304 in FIG. 23) of this sub-embodiment,

$${N}_{1} = 2 , {S}_{1} = \{ ( 0 , \frac{{L}_{1}}{4} ) , ( 2 , \frac{{L}_{1}}{4} ) \} , {N}_{2} = 1 , {S}_{2} = \{ ( 1 , 0 ) \} , {N}_{3} = 15 , {S}_{3} = \{ ( 0 , 0 ) , ( 0 , \frac{{L}_{1}}{4} + {L}_{2} ) , ( 2 , 0 ) , ( 2 , \frac{{L}_{1}}{4} + {L}_{2} ) , ( 3 , 0 ) , ( 4 , 0 ) , ( 5 , 0 ) , ( 6 , 0 ) , … … , ( {N}_{symb} - 1 , 0 ) \} .$$

For a fifth example (e.g., 2305 in FIG. 23) of this sub-embodiment,

$${N}_{1} = 2 , {S}_{1} = \{ ( 0 , \frac{{L}_{1}}{4} ) , ( 3 , \frac{{L}_{1}}{4} ) \} , {N}_{2} = 2 , {S}_{2} = \{ ( 1 , 0 ) , ( 2 , 0 ) \} , {N}_{3} = 14 , {S}_{3} = \{ ( 0 , 0 ) , ( 0 , \frac{{L}_{1}}{4} + {L}_{2} ) , ( 3 , 0 ) , ( 3 , \frac{{L}_{1}}{4} + {L}_{2} ) , ( 4 , 0 ) , ( 5 , 0 ) , ( 6 , 0 ) , … … , ( {N}_{symb} - 1 , 0 ) \} .$$

For a sixth example (e.g., 2306 in FIG. 23) of this sub-embodiment,

$${N}_{1} = 3 , {S}_{1} = \{ ( 0 , \frac{{L}_{1}}{4} ) , ( 1 , \frac{{L}_{1}}{4} ) , ( 2 , \frac{{L}_{1}}{4} ) \} , {N}_{2} = 2 , {S}_{2} = \{ ( 3 , 0 ) , ( 4 , 0 ) \} , {N}_{3} = 15 , {S}_{3} = \{ ( 0 , 0 ) , ( 0 , \frac{{L}_{1}}{4} + {L}_{2} ) , ( 1 , 0 ) , ( 1 , \frac{{L}_{1}}{4} + {L}_{2} ) , ( 2 , 0 ) , ( 2 , \frac{{L}_{1}}{4} + {L}_{2} ) , ( 5 , 0 ) , ( 6 , 0 ) , … … , ( {N}_{symb} - 1 , 0 ) \} .$$

For a seventh example (e.g., 2307 in FIG. 23) of this sub-embodiment,

$${N}_{1} = 3 , {S}_{1} = \{ ( 1 , \frac{{L}_{1}}{4} ) , ( 3 , \frac{{L}_{1}}{4} ) , ( 4 , \frac{{L}_{1}}{4} ) \} , {N}_{2} = 2 , {S}_{2} = \{ ( 0 , 0 ) , ( 2 , 0 ) \} , {N}_{3} = 15 , {S}_{3} = \{ ( 1 , 0 ) , ( 1 , \frac{{L}_{1}}{4} + {L}_{2} ) , ( 3 , 0 ) , ( 3 , \frac{{L}_{1}}{4} + {L}_{2} ) , ( 4 , 0 ) , ( 4 , \frac{{L}_{1}}{4} + {L}_{2} ) , ( 5 , 0 ) , ( 6 , 0 ) , … … , ( {N}_{symb} - 1 , 0 ) \} .$$

For a eighth example (e.g., 2308 in FIG. 23) of this sub-embodiment,

$${N}_{1} = 3 , {S}_{1} = \{ ( 0 , \frac{{L}_{1}}{4} ) , ( 2 , \frac{{L}_{1}}{4} ) , ( 4 , \frac{{L}_{1}}{4} ) \} , {N}_{2} = 2 , {S}_{2} = \{ ( 1 , 0 ) , ( 3 , 0 ) \} , {N}_{3} = 15 , {S}_{3} = \{ ( 0 , 0 ) , ( 0 , \frac{{L}_{1}}{4} + {L}_{2} ) , ( 2 , 0 ) , ( 2 , \frac{{L}_{1}}{4} + {L}_{2} ) , ( 4 , 0 ) , ( 4 , \frac{{L}_{1}}{4} + {L}_{2} ) , ( 5 , 0 ) , ( 6 , 0 ) , … … , ( {N}_{symb} - 1 , 0 ) \} .$$

For a ninth example (e.g., 2401 in FIG. 24) of this sub-embodiment,

$${N}_{1} = 2 , {S}_{1} = \{ ( 1 , \frac{{L}_{1}}{4} ) , ( 2 , \frac{{L}_{1}}{4} ) \} , {N}_{2} = 1 , {S}_{2} = \{ ( 3 , 0 ) \} , {N}_{3} = 15 , {S}_{3} = \{ ( 0 , 0 ) , ( 1 , 0 ) , ( 1 , \frac{{L}_{1}}{4} + {L}_{2} ) , ( 2 , 0 ) , ( 2 , \frac{{L}_{1}}{4} + {L}_{2} ) , ( 4 , 0 ) , ( 5 , 0 ) , ( 6 , 0 ) , … … , ( {N}_{symb} - 1 , 0 ) \} .$$

For a tenth example (e.g., 2402 in FIG. 24) of this sub-embodiment,

$${N}_{1} = 2 , {S}_{1} = \{ ( 1 , \frac{{L}_{1}}{4} ) , ( 2 , \frac{{L}_{1}}{4} ) \} , {N}_{2} = 2 , {S}_{2} = \{ ( 3 , 0 ) , ( 4 , 0 ) \} , {N}_{3} = 14 , {S}_{3} = \{ ( 0 , 0 ) , ( 1 , 0 ) , ( 1 , \frac{{L}_{1}}{4} + {L}_{2} ) , ( 2 , 0 ) , ( 2 , \frac{{L}_{1}}{4} + {L}_{2} ) , ( 5 , 0 ) , ( 6 , 0 ) , … … , ( {N}_{symb} - 1 , 0 ) \} .$$

For a eleventh example (e.g., 2403 in FIG. 24) of this sub-embodiment,

$${N}_{1} = 2 , {S}_{1} = \{ ( 1 , \frac{{L}_{1}}{4} ) , ( 3 , \frac{{L}_{1}}{4} ) \} , {N}_{2} = 2 , {S}_{2} = \{ ( 2 , 0 ) , ( 4 , 0 ) \} , {N}_{3} = 14 , {S}_{3} = \{ ( 0 , 0 ) , ( 1 , 0 ) , ( 1 , \frac{{L}_{1}}{4} + {L}_{2} ) , ( 3 , 0 ) , ( 3 , \frac{{L}_{1}}{4} + {L}_{2} ) , ( 5 , 0 ) , ( 6 , 0 ) , … … , ( {N}_{symb} - 1 , 0 ) \} .$$

For a twelfth example (e.g., 2404 in FIG. 24) of this sub-embodiment,

$${N}_{1} = 2 , {S}_{1} = \{ ( 1 , \frac{{L}_{1}}{4} ) , ( 3 , \frac{{L}_{1}}{4} ) \} , {N}_{2} = 1 , {S}_{2} = \{ ( 2 , 0 ) \} , {N}_{3} = 15 , {S}_{3} = \{ ( 0 , 0 ) , ( 1 , 0 ) , ( 1 , \frac{{L}_{1}}{4} + {L}_{2} ) , ( 3 , 0 ) , ( 3 , \frac{{L}_{1}}{4} + {L}_{2} ) , ( 4 , 0 ) , ( 5 , 0 ) , ( 6 , 0 ) , … … , ( {N}_{symb} - 1 , 0 ) \} .$$

For a thirteenth example (e.g., 2405 in FIG. 24) of this sub-embodiment,

$${N}_{1} = 2 , {S}_{1} = \{ ( 1 , \frac{{L}_{1}}{4} ) , ( 4 , \frac{{L}_{1}}{4} ) \} , {N}_{2} = 2 , {S}_{2} = \{ ( 2 , 0 ) , ( 3 , 0 ) \} , {N}_{3} = 14 , {S}_{3} = \{ ( 0 , 0 ) , ( 1 , 0 ) , ( 1 , \frac{{L}_{1}}{4} + {L}_{2} ) , ( 4 , 0 ) , ( 4 , \frac{{L}_{1}}{4} + {L}_{2} ) , ( 4 , 0 ) , ( 6 , 0 ) , … … , ( {N}_{symb} - 1 , 0 ) \} .$$

For a fourteenth example (e.g., 2406 in FIG. 24) of this sub-embodiment,

$${N}_{1} = 3 , {S}_{1} = \{ ( 1 , \frac{{L}_{1}}{4} ) , ( 2 , \frac{{L}_{1}}{4} ) ( 3 , \frac{{L}_{1}}{4} ) \} , {N}_{2} = 2 , {S}_{2} = \{ ( 4 , 0 ) , ( 5 , 0 ) \} , {N}_{3} = 15 , {S}_{3} = \{ ( 0 , 0 ) , ( 1 , 0 ) , ( 1 , \frac{{L}_{1}}{4} + {L}_{2} ) , ( 2 , 0 ) , ( 2 , \frac{{L}_{1}}{4} + {L}_{2} ) , ( 3 , 0 ) , ( 3 , \frac{{L}_{1}}{4} + {L}_{2} ) , ( 6 , 0 ) , … … , ( {N}_{symb} - 1 , 0 ) \} .$$

For a fifteenth example (e.g., 2407 in FIG. 24) of this sub-embodiment,

$${N}_{1} = 3 , {S}_{1} = \{ ( 2 , \frac{{L}_{1}}{4} ) , ( 4 , \frac{{L}_{1}}{4} ) ( 5 , \frac{{L}_{1}}{4} ) \} , {N}_{2} = 2 , {S}_{2} = \{ ( 1 , 0 ) , ( 3 , 0 ) \} , {N}_{3} = 15 , {S}_{3} = \{ ( 0 , 0 ) , ( 2 , 0 ) , ( 2 , \frac{{L}_{1}}{4} + {L}_{2} ) , ( 4 , 0 ) , ( 4 , \frac{{L}_{1}}{4} + {L}_{2} ) , ( 5 , 0 ) , ( 5 , \frac{{L}_{1}}{4} + {L}_{2} ) , ( 6 , 0 ) , … … , ( {N}_{symb} - 1 , 0 ) \} .$$

For a sixteenth example (e.g., 2408 in FIG. 24) of this sub-embodiment,

$${N}_{1} = 3 , {S}_{1} = \{ ( 1 , \frac{{L}_{1}}{4} ) , ( 3 , \frac{{L}_{1}}{4} ) ( 5 , \frac{{L}_{1}}{4} ) \} , {N}_{2} = 2 , {S}_{2} = \{ ( 2 , 0 ) , ( 4 , 0 ) \} , {N}_{3} = 15 , {S}_{3} = \{ ( 0 , 0 ) , ( 1 , 0 ) , ( 1 , \frac{{L}_{1}}{4} + {L}_{2} ) , ( 3 , 0 ) , ( 3 , \frac{{L}_{1}}{4} + {L}_{2} ) , ( 5 , 0 ) , ( 5 , \frac{{L}_{1}}{4} + {L}_{2} ) , ( 6 , 0 ) , … … , ( {N}_{symb} - 1 , 0 ) \} .$$

In one further evaluation for the examples of this sub-embodiment, the SSB with 14 OFDM symbols can be mapped from a first OFDM symbol in a slot, e.g., #0 of the SSB is aligned with #0 of a slot.

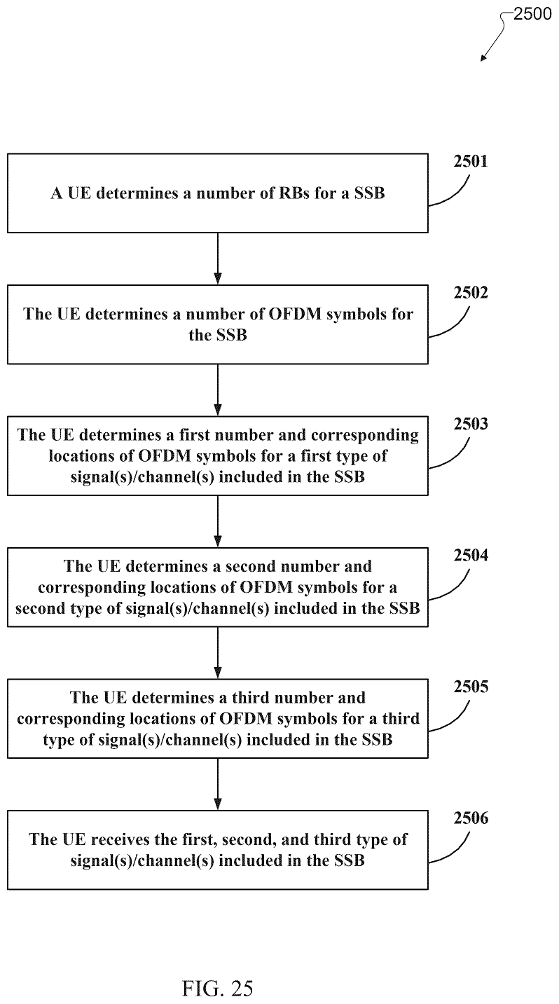

FIG. 25 illustrates a flowchart of an example UE procedure 2500 for receiving signal(s)/channel(s) according to embodiments of the present disclosure. For example, procedure 2500 can be performed by the UE 116 of FIG. 3 and a corresponding or analogous process may be performed by the BS 102 of FIG. 2. This example is for illustration only and other embodiments can be used without departing from the scope of the present disclosure.

In one embodiment, an example UE procedure for receiving a SSB is shown in FIG. 25. The procedure 2500 begins in 2501, a UE determines a number of RBs for a SSB. In 2502, the UE determines a number of OFDM symbols for the SSB. In 2503, the UE determines a first number and corresponding locations of OFDM symbols for a first type of signal(s)/channel(s) included in the SSB. For example, the type of signal(s)/channel(s) may be PSS, SSS, or PBCH. In 2504, the UE determines a second number and corresponding locations of OFDM symbols for a second type of signal(s)/channel(s) included in the SSB. For example, the type of signal(s)/channel(s) may be PSS, SSS, or PBCH. In 2505, the UE determines a third number and corresponding locations of OFDM symbols for a third type of signal(s)/channel(s) included in the SSB. For example, the type of signal(s)/channel(s) may be PSS, SSS, or PBCH. In 2506, the UE receives the first, second, and third type of signal(s)/channel(s) included in the SSB.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
identify a structure for a synchronization signals/physical broadcast channel (SS/PBCH) block, the structure including a first number N_{symb} of orthogonal frequency-division multiplexing (OFDM) symbols in a time domain and a second number N_{RB} of resource blocks (RBs) in a frequency domain;
identify, from the N_{symb} OFDM symbols, a third number N₁ of OFDM symbols mapped for a primary synchronization signal (PSS), where N₁>1; and
identify, from the N_{symb} OFDM symbols, a fourth number N₂ of OFDM symbols mapped for a secondary synchronization signal (SSS), where N₂>1; and
a transceiver operably coupled to the processor, the transceiver configured to receive the SS/PBCH block based on the structure.

2. The UE of claim 1, wherein the N_{symb} OFDM symbols are consecutive and within a slot.

3. The UE of claim 1, wherein the N₁ OFDM symbols are first N₁ consecutive OFDM symbols within the N_{symb} OFDM symbols.

4. The UE of claim 1, wherein the N₂ OFDM symbols are non-consecutive OFDM symbols within the N_{symb} OFDM symbols.

5. The UE of claim 1, wherein N_{RB}=12.

6. The UE of claim 1, wherein:
a first sequence for the PSS is mapped to center 127 subcarriers within 12·N_{RB} subcarriers of the N_{RB} RBs, in each OFDM symbol within the N₁ OFDM symbols; and
a second sequence for the SSS is mapped to center 127 subcarriers within 12·N_{RB} subcarriers of the N_{RB} RBs, in each OFDM symbol within the N₂ OFDM symbols.

7. The UE of claim 1, wherein remaining N_{symb}−N₁-N₂ OFDM symbols within the N_{symb} OFDM symbols are mapped for a PBCH in the SS/PBCH block.

8. A base station (BS) in a wireless communication system, the BS comprising:
a processor configured to:
determine a structure for a synchronization signals/physical broadcast channel (SS/PBCH) block, the structure including a first number N_{symb} of orthogonal frequency-division multiplexing (OFDM) symbols in a time domain and a second number N_{RB} of resource blocks (RBs) in a frequency domain;
determine, from the N_{symb} OFDM symbols, a third number N₁ of OFDM symbols mapped for a primary synchronization signal (PSS), where N₁>1; and
determine, from the N_{symb} OFDM symbols, a fourth number N₂ of OFDM symbols mapped for a secondary synchronization signal (SSS), where N₂>1; and
a transceiver operably coupled to the processor, the transceiver configured to transmit the SS/PBCH block based on the structure.

9. The BS of claim 8, wherein the N_{symb} OFDM symbols are consecutive and within a slot.

10. The BS of claim 8, wherein the N₁ OFDM symbols are first N₁ consecutive OFDM symbols within the N_{symb} OFDM symbols.

11. The BS of claim 8, wherein the N₂ OFDM symbols are non-consecutive OFDM symbols within the N_{symb} OFDM symbols.

12. The BS of claim 8, wherein N_{RB}=12.

13. The BS of claim 8, wherein:
a first sequence for the PSS is mapped to center 127 subcarriers within 12·N_{RB} subcarriers of the N_{RB} RBs, in each OFDM symbol within the N₁ OFDM symbols; and
a second sequence for the SSS is mapped to center 127 subcarriers within 12·N_{RB} subcarriers of the N_{RB} RBs, in each OFDM symbol within the N₂ OFDM symbols.

14. The BS of claim 8, wherein remaining N_{symb}−N₁−N₂ OFDM symbols within the N_{symb} OFDM symbols are mapped for a PBCH in the SS/PBCH block.

15. A method of a user equipment (UE) in a wireless communication system, the method comprising:
identifying a structure for a synchronization signals/physical broadcast channel (SS/PBCH) block, the structure including a first number N_{symb} of orthogonal frequency-division multiplexing (OFDM) symbols in a time domain and a second number N_{RB} of resource blocks (RBs) in a frequency domain;
identifying, from the N_{symb} OFDM symbols, a third number N₁ of OFDM symbols mapped for a primary synchronization signal (PSS), where N₁>1;
identifying, from the N_{symb} OFDM symbols, a fourth number N₂ of OFDM symbols mapped for a secondary synchronization signal (SSS), where N₂>1; and
receiving the SS/PBCH block based on the structure.

16. The method of claim 15, wherein the N_{symb} OFDM symbols are consecutive and within a slot.

17. The method of claim 15, wherein:
the N₁ OFDM symbols are first N₁ consecutive OFDM symbols within the N_{symb} OFDM symbols; and
the N₂ OFDM symbols are non-consecutive OFDM symbols within the N_{symb} OFDM symbols.

18. The method of claim 15, wherein N_{RB}=12·

19. The method of claim 15, wherein:
a first sequence for the PSS is mapped to center 127 subcarriers within 12·N_{RB} subcarriers of the N_{RB} RBs, in each OFDM symbol within the N₁ OFDM symbols; and
a second sequence for the SSS is mapped to center 127 subcarriers within 12·N_{RB} subcarriers of the N_{RB} RBs, in each OFDM symbol within the N₂ OFDM symbols.

20. The method of claim 15, wherein remaining N_{symb}−M₁−N₂ OFDM symbols within the N_{symb} OFDM symbols are mapped for a PBCH in the SS/PBCH block.
